(19) United States
(12) Patent Application Publication
(10) Pub. No.: US 2014/0253388 A1
(43) Pub. Date: Sep. 11, 2014

(54) SYNCHRONIZATION OF ANCHOR UNITS IN A POSITION LOCATION TRACKING SYSTEM

(71) Applicant: QUALCOMM INCORPORATED, San Diego, CA (US)

(72) Inventors: Ahmad Jalali, Rancho Santa Fe, CA (US); Alok K. GUPTA, San Diego, CA (US)

(73) Assignee: QUALCOMM Incorporated, San Diego, CA (US)

(21) Appl. No.: 13/789,897

(22) Filed: Mar. 8, 2013

(51) Int. Cl. G01S 5/04

(52) U.S. Cl. CPC G01S 5/04
USPC 342/458

(57) ABSTRACT

Methods, systems, and devices are described for tracking an asset or person using a synchronized set of anchor units. A tag attached to the asset or person has a clock offset relative to the anchor units, which in turn have clock offsets relative to each other. To remove the effect of the clock offset from the tag when estimating the location of the tag, the anchor units are synchronized by determining their clock offsets through signals wirelessly transmitted between the anchor units. The clock offsets may be obtained when there is a clear line-of-sight (LOS) path between anchor units as well as when the LOS path is obstructed. The range measurements that produce the estimate of the location of the tag are then determined from preamble information provided by the tag and from the clock offsets determined for the anchor units.

### BACKGROUND

In some settings, such as in indoor and enterprise environments, it may be important to easily locate various types of assets and/or people. Such settings include hospitals, retail stores, and warehouses, to name a few. The accuracy and speed with which the location of assets or people may be monitored in an indoor setting may be critical in determining the usefulness of the location tracking system. In addition, having a location tracking system that is cost effective and that can provide continuous location monitoring is also desirable.

Different systems and devices may be used to locate assets and/or people in a particular indoor environment. In one example, a WiFi network, or some other radio frequency network deployed throughout at least a portion of the indoor environment, may be configured to perform indoor location tracking. In such a system, there may be multiple WiFi access points (APs), or WiFi anchor units (AUs), placed at specific locations in the indoor environment. A WiFi tag may be attached to each mobile asset and/or to each person to be tracked. The WiFi tag and the WiFi APs send signals back and forth to determine the distance between the WiFi tag and the WiFi APs. Once the distances between the WiFi tag and at least three different WiFi APs are obtained, triangulation may be used to estimate the location of the asset or person attached to the WiFi tag. Because the WiFi tag transmits and receives signals to determine the distance to a WiFi AP, any clock offset from the WiFi tag is removed as part of the distance calculations. Synchronization among the various WiFi APs is not needed to make the triangulation calculations since the clock offset from the WiFi has no effect on the WiFi network,

The accuracy of WiFi-based indoor tracking systems may be insufficient for certain settings and, therefore, other radio frequency technologies may be considered. However, for many of these other radio frequency technologies, having tags with both transmission and reception capabilities to enable distance measurements used for triangulation calculations may present some challenges. For example, adding a receiver to the tag to detect the return of a beacon signal from an anchor unit may not only increase the cost of the tag, but it may also increase the power consumption of the tag, thus significantly reducing its battery life. Having tags with only transmission capabilities may involve synchronizing the anchor units of the location tracking system, which was not required in the case of the WiFi network.

Thus, to achieve accurate and cost-effective location tracking that is suitable for indoor environments, it may be desirable to use systems, methods, and devices that enable synchronization of the anchor units that are used in a location tracking system.

### SUMMARY

Methods, systems, and devices are provided that may address problems pertaining to asset and/or people tracking in an indoor or enterprise environment. In some embodiments, a location tracking system uses tags on assets or people to transmit preamble signals. Anchor units installed across the area covered by the location tracking system are configured to make range measurements (i.e., pseudo-range measurements) from the preamble signals sent by the tags. These measurements may be used to estimate the location of the tag by triangulating or trilateration. The clock of one of the anchor units may be used as a reference clock with that anchor unit being referred to as the reference anchor unit or R-AU. The pseudo-range estimates between the tags and the anchor units, and between each of the anchor units, are then made in reference to the R-AU. The clock of any one tag, however, is offset with respect to the clocks of the anchor units. Moreover, there is an offset between the clocks of the anchor units and that of the R-AU. When the clocks of the anchor units are synchronized, that is, when the clock offsets between the anchor units and the R-AU are removed from or accounted for in the range measurements, the clock offset between the tag and the R-AU is removed by the triangulation calculations because the calculations implicitly use one extra measurement to estimate the tag clock offset.

In some embodiments, the anchor units are synchronized by determining their clock offsets through signals wirelessly transmitted between the anchor units. The clock offsets may be obtained when there is a clear line-of-sight (LOS) path between anchor units as well as when the LOS path is obstructed. The range measurements that produce the estimate of the location of the tag are then determined from information in the preamble signals sent by the tag and from the clock offsets determined for the anchor units.

A method for location tracking includes determining clock offsets between anchor units configured to track an asset or person, where the determination is based on signals wirelessly transmitted between the anchor units. Range measurements between a tag attached to the asset or person and at least a portion of the anchor units are determined. The range measurements may be based on information in one or more signals transmitted by the tag when the tag is at a particular location, and on the clock offsets of the at least a portion of the anchor units. An estimate of the particular location from which the tag transmitted the one or more signals may be determined based on the range measurements.

In some embodiments, determining the clock offsets between anchor units includes determining an estimate of the distance between a first anchor unit of the anchor units and a second anchor unit of the anchor units, where the distance estimate is based on two-way time-of-flight information between the first anchor unit and the second anchor unit. The clock offset between the first anchor unit and the second anchor unit may be determined based on the distance estimate.

In some embodiments, a first group of the anchor units and a second group of the anchor units different from the first group are identified. The wireless transmission of ranging information from anchor units in the first group to anchor units in the second group may be scheduled during a first period of time. The wireless transmission of ranging information from anchor units in the second group to anchor units in the first group may be scheduled during a second period of time subsequent to the first period of time. The clock offsets between the anchor units may be determined based on two-way time-of-flight information resulting from the transmission of ranging information during the first period of time and during the second period of time. The ranging information transmitted during the first period of time and during the second period of time is transmitted using a first frequency spectrum, and the one or more signals transmitted by the tag are transmitted using a second frequency spectrum different from the first frequency spectrum.

In some embodiments, the method further includes identifying one of the anchor units as a reference anchor unit, and determining a clock offset between each of the other anchor units and the reference anchor unit based on the clock offsets between the anchor units.

In some embodiments, determining the clock offsets between anchor units includes determining an estimate of the distance between a first anchor unit of the anchor units and a second anchor unit of the anchor units, where the distance estimate is based on information in a packet received by the second anchor unit from the first anchor unit. The clock offset between the first anchor unit and the second anchor unit may be determined based on the distance estimate. The packet information may include a timestamp that indicates a time of transmission of the packet from the first anchor unit. The packet information may include a ranging preamble configured to determine a time of arrival of the packet at the second anchor unit. The packet may be received by the second anchor unit via a first frequency spectrum, where the information in the packet includes a ranging preamble configured to determine a time of arrival of the packet at the second anchor unit. A timestamp may be received by the second anchor unit via a second frequency spectrum different from the first frequency spectrum, where the timestamp indicates a time of transmission of the packet from the first anchor unit. Moreover, a time of arrival of the packet at the second anchor unit may be determined based on a ranging preamble in the packet information, and the distance estimate may be determined based on the two-way time-of-flight measurements. Alternatively, the distance between anchor units may be measured at installation time, or may be estimated based on the position of the anchor units on the map that is entered into a configuration file at installation time.

In some embodiments, determining the clock offsets between anchor units includes sending packets between a first anchor unit of the anchor units and a second anchor unit of the anchor units, where a timing of the sending of the packets and a timing of the receiving of the packets are used to determine the clock offset between the first anchor unit and the second anchor unit when a line-of-sight between the first anchor unit and the second anchor unit is blocked.

In some embodiments, a subset of the anchor units that do not have a main path between two anchor units blocked is identified. The clock offsets between anchor units may be determined from the subset of the anchor units.

In some embodiments, determining the clock offsets between anchor units includes identifying one of the anchor units as a master reference anchor unit, synchronizing the master reference anchor unit to one or more of the remaining anchor units, and identifying at least one acting reference anchor unit from the one or more of anchor units synchronized to the master reference anchor unit. An additional at least one acting reference unit may be identified from one or more anchor units synchronized to the at least one acting reference anchor unit.

A location tracking system includes means for determining clock offsets between anchor units configured to track an asset or person, the determination being based on signals wirelessly transmitted between the anchor units. The system also includes means for determining range measurements between a tag attached to the asset or person and at least a portion of the anchor units. The range measurements may be based on information in one or more signals transmitted by the tag when the tag is at a particular location, and on the clock offsets of the at least a portion of the anchor units. The system further includes means for determining an estimate, based on the range measurements, of the particular location from which the tag transmitted the one or more signals.

In some embodiments, the means for determining the clock offsets between anchor units include means for determining an estimate of the distance between a first anchor unit of the anchor units and a second anchor unit of the anchor units, where the distance estimate is based on two-way time-of-flight information between the first anchor unit and the second anchor unit, and means for determining the clock offset between the first anchor unit and the second anchor unit based on the distance estimate.

In some embodiments, the system includes means for identifying a first group of the anchor units and a second group of the anchor units different from the first group. The system may also include means for scheduling the wireless transmission of ranging information from anchor units in the first group to anchor units in the second group during a first period of time, and from anchor units in the second group to anchor units in the first group during a second period of time subsequent to the first period of time. The system may further include means for determining the clock offsets between the anchor units based on two-way time-of-flight information resulting from the transmission of ranging information during the first period of time and during the second period of time. The ranging information transmitted during the first period of time and during the second period of time may be transmitted using a first frequency spectrum. The one or more signals transmitted by the tag may be transmitted using a second frequency spectrum different from the first frequency spectrum.

In some embodiments, the system includes means for identifying one of the anchor units as a reference anchor unit, and means for determining a clock offset between each of the other anchor units and the reference anchor unit based on the clock offsets between the anchor units.

In some embodiments, the means for determining the clock offsets between anchor units include means for determining an estimate of the distance between a first anchor unit of the anchor units and a second anchor unit of the anchor units, where the distance estimate is based on information in a packet received by the second anchor unit from the first anchor unit, and means for determining the clock offset between the first anchor unit and the second anchor unit based on the distance estimate. The packet information may include a timestamp that indicates a time of transmission of the packet from the first anchor unit. The packet information may include a ranging preamble configured to determine a time of arrival of the packet at the second anchor unit. The packet may be received by the second anchor unit via a first frequency spectrum, where the information in the packet includes a ranging preamble configured to determine a time of arrival of the packet at the second anchor unit. A timestamp may be received by the second anchor unit via a second frequency spectrum different from the first frequency spectrum, where the timestamp indicates a time of transmission of the packet from the first anchor unit. The system may further include means for determining a time of arrival of the packet at the second anchor unit based on a ranging preamble in the packet information, and means for determining the distance estimate based on the time of arrival of the packet.

In some embodiments, the means for determining the clock offsets between anchor units include means for sending packets between a first anchor unit of the anchor units and a second anchor unit of the anchor units, where a timing of the sending of the packets and a timing of the receiving of the packets are used to determine the clock offset between the first anchor unit and the second anchor unit when a line-of-sight between the first anchor unit and the second anchor unit is blocked.

In some embodiments, the system further includes means for identifying a subset of the anchor units that do not have a main path between two anchor units blocked, and means for determining the clock offsets between anchor units from the subset of the anchor units.

In some embodiments, the means for determining the clock offsets between anchor units includes means for identifying one of the anchor units as a master reference anchor unit, means for synchronizing the master reference anchor unit to one or more of the remaining anchor units, and means for identifying at least one acting reference anchor unit from the one or more of anchor units synchronized to the master reference anchor unit. The means for determining the clock offsets between anchor units may further comprise means for identifying an additional at least one acting reference unit from one or more anchor units synchronized to the at least one acting reference anchor unit.

A location tracking device includes at least one processor communicatively coupled with a memory, where the memory has executable code that, when executed by the at least one processor, causes the at least one processor to determine clock offsets between anchor units configured to track an asset or person the determination being based on signals wirelessly transmitted between the anchor units. The executable code also causes the at least one processor to determine range measurements between a tag attached to the asset or person and at least a portion of the anchor units. The range measurements may be based on information in one or more signals transmitted by the tag when the tag is at a particular location, and on the clock offsets of the at least a portion of the anchor units. The executable code further causes the at least one processor to determine, based on the range measurements, an estimate of the particular location from which the tag transmitted the one or more signals.

In some embodiments, the executable code causes the at least one processor to determine an estimate of the distance between a first anchor unit of the anchor units and a second anchor unit of the anchor units, where the distance estimate is based on two-way time-of-flight information between the first anchor unit and the second anchor unit, and to determine the clock offset between the first anchor unit and the second anchor unit based on the distance estimate.

In some embodiments, the executable code causes the at least one processor to identify a first group of the anchor units and a second group of the anchor units different from the first group. The executable code also causes the at least one processor to schedule the wireless transmission of ranging information from anchor units in the first group to anchor units in the second group during a first period of time, and from anchor units in the second group to anchor units in the first group during a second period of time subsequent to the first period of time. The executable code further causes the at least one processor to determine the clock offsets between the anchor units based on two-way time-of-flight information resulting from the transmission of ranging information during the first period of time and during the second period of time. The ranging information transmitted during the first period of time and during the second period of time may be transmitted using a first frequency spectrum. The one or more signals transmitted by the tag may be transmitted using a second frequency spectrum different from the first frequency spectrum.

In some embodiments, the executable code causes the at least one processor to identify one of the anchor units as a reference anchor unit, and to determine a clock offset between each of the other anchor units and the reference anchor unit based on the clock offsets between the anchor units.

In some embodiments, the executable code causes the at least one processor to determine an estimate of the distance between a first anchor unit of the anchor units and a second anchor unit of the anchor units, where the distance estimate is based on information in a packet received by the second anchor unit from the first anchor unit. The executable code may cause the at least one processor to determine the clock offset between the first anchor unit and the second anchor unit based on the distance estimate. The packet information may include a timestamp that indicates a time of transmission of the packet from the first anchor unit. The packet information may include a ranging preamble configured to determine a time of arrival of the packet at the second anchor unit. The packet may be received by the second anchor unit via a first frequency spectrum, where the information in the packet includes a ranging preamble configured to determine a time of arrival of the packet at the second anchor unit. A timestamp may be received by the second anchor unit via a second frequency spectrum different from the first frequency spectrum, where the timestamp indicates a time of transmission of the packet from the first anchor unit.

In some embodiments, the executable code causes the at least one processor to determine a time of arrival of the packet at the second anchor unit based on a ranging preamble in the packet information, and to determine the distance estimate based on the time of arrival of the packet.

In some embodiments, the executable code causes the at least one processor to send packets between a first anchor unit of the anchor units and a second anchor unit of the anchor units, where a timing of the sending of the packets and a timing of the receiving of the packets are used to determine the clock offset between the first anchor unit and the second anchor unit when a line-of-sight between the first anchor unit and the second anchor unit is blocked.

In some embodiments, the executable code causes the at least one processor to identify a subset of the anchor units that do not have a main path between two anchor units blocked, and to determine the clock offsets between anchor units from the subset of the anchor units.

In some embodiments, the executable code causes the at least one processor to identify one of the anchor units as a master reference anchor unit, to synchronize the master reference anchor unit to one or more of the remaining anchor units, and to identify at least one acting reference anchor unit from the one or more of anchor units synchronized to the master reference anchor unit. The executable code may cause the at least one processor to identify an additional at least one acting reference unit from one or more anchor units synchronized to the at least one acting reference anchor unit.

A computer program product for location tracking includes a non-transitory computer-readable medium having code configured to determine clock offsets between anchor units configured to track an asset or person, where the determination is based on signals wirelessly transmitted between the anchor units. The computer-readable medium also has code configured to determine range measurements between a tag attached to the asset or person and at least a portion of the anchor units. The range measurements may be based on information in one or more signals transmitted by the tag when the tag is at a particular location, and on the clock offsets of the at least a portion of the anchor units. The computer-readable medium further has code configured to determine, based on the range measurements, an estimate of the particular location from which the tag transmitted the one or more signals.

In some embodiments, the computer-readable medium has code configured to determine an estimate of the distance between a first anchor unit of the anchor units and a second anchor unit of the anchor units, where the distance estimate is based on two-way time-of-flight information between the first anchor unit and the second anchor unit. The computer-readable medium may also have code configured to determine the clock offset between the first anchor unit and the second anchor unit based on the distance estimate.

In some embodiments, the computer-readable medium has code configured to identify a first group of the anchor units and a second group of the anchor units different from the first group. The computer-readable medium may also have code configured to schedule the wireless transmission of ranging information from anchor units in the first group to anchor units in the second group during a first period of time, and from anchor units in the second group to anchor units in the first group during a second period of time subsequent to the first period of time. The computer-readable medium may further have code configured to determine the clock offsets between the anchor units based on two-way time-of-flight information resulting from the transmission of ranging information during the first period of time and during the second period of time. The ranging information transmitted during the first period of time and during the second period of time may be transmitted using a first frequency spectrum. The one or more signals transmitted by the tag may be transmitted using a second frequency spectrum different from the first frequency spectrum.

In some embodiments, the computer-readable medium has code configured to identify one of the anchor units as a reference anchor unit, and code configured to determine a clock offset between each of the other anchor units and the reference anchor unit based on the clock offsets between the anchor units.

In some embodiments, the computer-readable medium has code configured to determine an estimate of the distance between a first anchor unit of the anchor units and a second anchor unit of the anchor units, where the distance estimate is based on information in a packet received by the second anchor unit from the first anchor unit. The computer-readable medium may also have code configured to determine the clock offset between the first anchor unit and the second anchor unit based on the distance estimate. The packet information may include a timestamp that indicates a time of transmission of the packet from the first anchor unit. The packet information may include a ranging preamble configured to determine a time of arrival of the packet at the second anchor unit. The packet may be received by the second anchor unit via a first frequency spectrum, where the information in the packet includes a ranging preamble configured to determine a time of arrival of the packet at the second anchor unit. A timestamp may be received by the second anchor unit via a second frequency spectrum different from the first frequency spectrum, where the timestamp indicates a time of transmission of the packet from the first anchor unit.

In some embodiments, the computer-readable medium has code configured to determine a time of arrival of the packet at the second anchor unit based on a ranging preamble in the packet information, and code configured to determine the distance estimate based on the time of arrival of the packet.

In some embodiments, the computer-readable medium has code configured to send packets between a first anchor unit of the anchor units and a second anchor unit of the anchor units, where a timing of the sending of the packets and a timing of the receiving of the packets are used to determine the clock offset between the first anchor unit and the second anchor unit when a line-of-sight between the first anchor unit and the second anchor unit is blocked.

In some embodiments, the computer-readable medium has code configured to identify a subset of the anchor units that do not have a main path between two anchor units blocked, and code configured to determine the clock offsets between anchor units from the subset of the anchor units.

In some embodiments, the computer-readable medium has code configured to identify one of the anchor units as a master reference anchor unit, code configured to synchronize the master reference anchor unit to one or more of the remaining anchor units, and code configured to identify at least one acting reference anchor unit from the one or more of anchor units synchronized to the master reference anchor unit. The computer-readable medium may also have code configured to identify an additional at least one acting reference unit from one or more anchor units synchronized to the at least one acting reference anchor unit.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a location tracking system according to various embodiments;

FIG. 2 shows a block diagram of an example of a tag unit according to various embodiments;

FIG. 3 shows a block diagram of an example of an anchor unit according to various embodiments;

FIG. 4 shows a block diagram of an example of a location tracking server according to various embodiments;

FIG. 5 shows a diagram that illustrates clock offsets between a tag unit and anchor units and between anchor units according to various embodiments;

FIG. 6A shows a diagram that illustrates a first example of clock offset estimation for anchor unit synchronization according to various embodiments;

FIG. 6B shows a diagram that illustrates a second example of clock offset estimation for anchor unit synchronization that is based on two-way time-of-flight measurements according to various embodiments;

FIG. 7A shows a diagram that illustrates an example of anchor unit preamable transmission during a first half of a preamble transmission cycle (PTC) according to various embodiments;

FIG. 7B shows a diagram that illustrates an example of anchor unit preamable transmission during a second half of a PTC according to various embodiments;

FIG. 7C shows a diagram that illustrates an example of network-wise time synchronization according to various embodiments;

FIG. 8A shows a diagram that illustrates an example of clock offset estimation with line-of-sight (LOS) path obstructed between anchor units according to various embodiments;

FIG. 8B shows a diagram that illustrates an example of a clock offset estimation between an anchor unit and a reference anchor unit according to various embodiments;

FIG. 8C shows a diagram that illustrates an example of clock offset estimation with LOS path obstructed between anchor units and non-resolvable multipaths according to various embodiments;

FIG. 9 is a flowchart of an example of a method for anchor unit synchronization according to various embodiments;

FIG. 10 is a flowchart of another example of a method for anchor unit synchronization according to various embodiments;

FIG. 11 is a flowchart of an example of a method for anchor unit synchronization with obstructed LOS path between anchor units according to various embodiments; and

FIG. 12 is a flowchart of an example of a method for a network-wise time synchronization scheme according to various embodiments.

### DETAILED DESCRIPTION

Methods, systems, and devices are provided for tracking an asset or person in an indoor or enterprise environment using a synchronized set of anchor units. A tag attached to the asset or person has a clock offset relative to the anchor units, which in turn have clock offsets relative to each other. To remove the effect of the clock offset from the tag when estimating the location of the tag, the anchor units are synchronized by determining their clock offsets through signals wirelessly transmitted between the anchor units. The clock offsets may be obtained when there is a clear LOS path between anchor units as well as when the LOS path is obstructed. When the LOS path is obstructed, different aspects of the clock offset may need to be considered. The range measurements that produce the estimate of the location of the tag are then determined from preamble information provided by signals transmitted by the tag and from the clock offsets determined for the anchor units.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

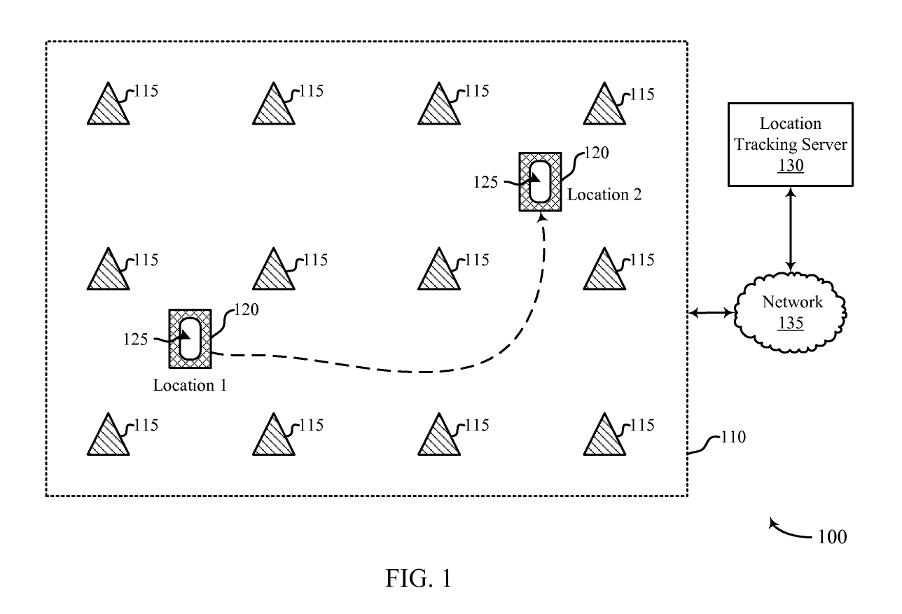

Referring first to FIG. 1, a block diagram illustrates an example of a location tracking system 100 in accordance with various embodiments. The system 100 provides location tracking across a coverage area 110 associated with an indoor or enterprise environment. For example, the coverage area 110 may represent an area of coverage inside a building, hospital, store, warehouse, or some other facility or space. In the coverage area 110, there are deployed multiple anchor units 115 at specific locations. One of the anchor units 115 may be used as a reference and may be referred to as the reference anchor unit or R-AU. Because of their stationary nature, the exact distance between any two of the anchor units 115 may be known throughout the operation of the system 100.

The arrangement of anchor units 115 shown in FIG. 1 is provided by way of illustration and not of limitation. For example, the anchor units 115 may be deployed or distributed within the coverage area 110 in different ways from the array pattern shown in FIG. 1 and at different distances from each other. Moreover, while the arrangement depicts a two-dimensional deployment, the anchor units 115 may also be deployed in a three-dimensional manner by placing some of the anchor units 115 in different floors or levels within the coverage area 110. In the system 100, different types of anchor units 115 may be used for location tracking. In some embodiments, the anchor units 115 may be associated with a radio network such as an ultra-wideband (UWB) network, for example.

The system 100 includes a location tracking server 130 that is connected to the anchor units 115 within the coverage area 110 through a network 135. The location tracking server 130 may receive information from the anchor units 115 to perform various types of calculations, including but not limited to distance calculations, clock offset calculations, and/or triangulation or trilateration calculations to estimate the location of an object or person being tracked within the coverage area 110. The location tracking server 130 may also schedule or coordinate various operations associated with the anchor units 115 including when to have an anchor unit 115 wirelessly communicate with other anchor units 115 to determine clock offsets between them. The location tracking server 130 may have information about different subsets of the anchor units 115 and may use that information to schedule or coordinate various operations between the subsets.

The anchor units 115 may receive wireless transmissions (e.g., preamble signals) from a tag unit 125 that is attached to a mobile asset or person 120 being tracked. The tag unit 125 may be a battery-operated device that periodically sends wireless transmissions to identify itself to the system 100. The information from the wireless transmissions may be received by the anchor units 115, typically those closest to the tag unit 125, and those anchor units 115 may collect, process, and store the information. For example, one of the anchor units 115 may use the information provided by the tag unit 125 to determine a distance between that anchor unit 115 and the tag unit 125. That distance calculation may be sent to the location tracking server 130 for further processing. In some embodiments, the anchor unit 115 collects the information from the tag unit 125 and sends the information to the location tracking server 130 to make the distance calculations and for further processing. The distance calculations from three or more anchor units 115 may be used to accurately estimate the location of the tag unit 125 within the coverage area 110.

An example of the operation of the system 100 of FIG. 1 is described next. The anchor units 115 are synchronized by determining the clock offsets for any one anchor units 115 with respect to the R-AU. Once the clock offsets are known, range measurements between some of the anchor units 115 and the tag unit 125 are made based on information provided by the tag unit 125. These range measurements are then used by the system 100 to identify the location of the tag unit 125. At first, the tag unit 125 is estimated to be at or near a location 1. Over time, the mobile asset or person 120 changes to a different location and the same process as described above may be performed along the way. At a later time, the tag unit 125 is estimated to be at or near a location 2, thereby tracking the movement of the mobile asset or person 120 from location 1 to location 2.

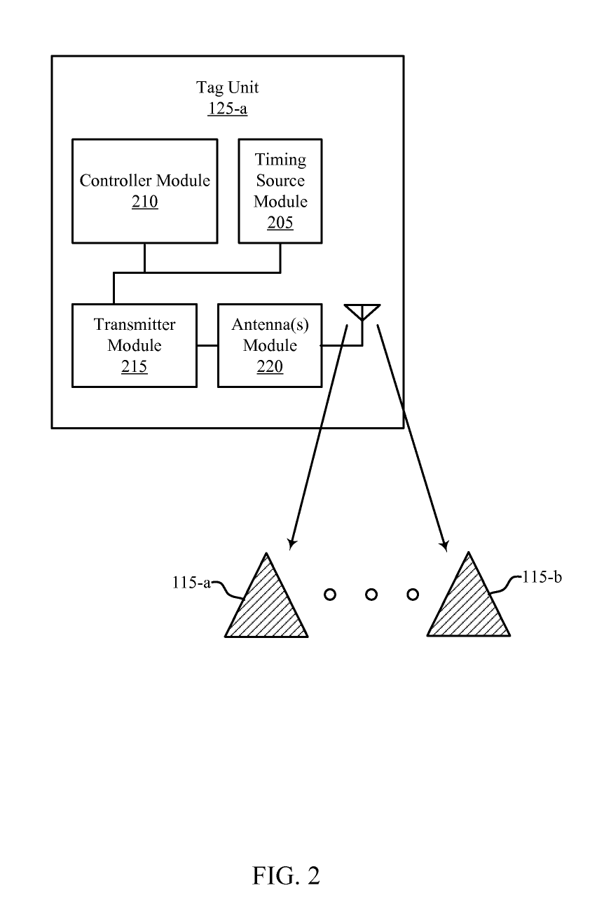

Turning now to FIG. 2, there is shown a tag unit 125-a that may be an example of the tag unit 125 of FIG. 1. The tag unit 125 includes a timing source module 205, a controller module 210, a transmitter module 215, and an antenna(s) module 220. Although not shown in FIG. 2, the tag units 125-a may also include a battery that enables the tag unit 125-a to be used as a battery-operated device. Each of these components may be in communication, directly or indirectly.

The timing source module 205 produces a clock and/or some other timing signal that is used by the tag unit 125-a to generate preamble signals for broadcasting. In some embodiments, the timing source 205 may include an oscillator and/or a frequency synthesizer that produces the appropriate clock for the operation of the tag unit 125-a.

The controller module 210 may include logic and/or code that enables it to control the operations of the tag unit 125-a. For example, the controller module 210 may include a microcontroller or a state machine to generate preamble signals for periodic transmission. The preamble signals typically include information that identifies the tag unit 125-a and distinguishes it from other tag units.

The transmitter module 215 may support a radio frequency (RF) communication technology to broadcast preamble signals through the antenna(s) module 220. For example, the transmitter module 215 may include a modulator (not shown) to modulate preamble information and provide the modulated preamble information to the antenna(s) module 220 for transmission as preamble signals. As shown in FIG. 2, the broadcast preamble signals from the tag unit 125-a may be received by one or more anchor units. In this example, the tag unit 125-a is shown to broadcast preamble signals to anchor units 115-a through 115-b.

Because the tag unit 125-a does not have signal reception capabilities, the tag unit 125-a may reduce power consumption, and may prolong the life of the battery, by going into a sleep mode when not broadcasting preamble signals.

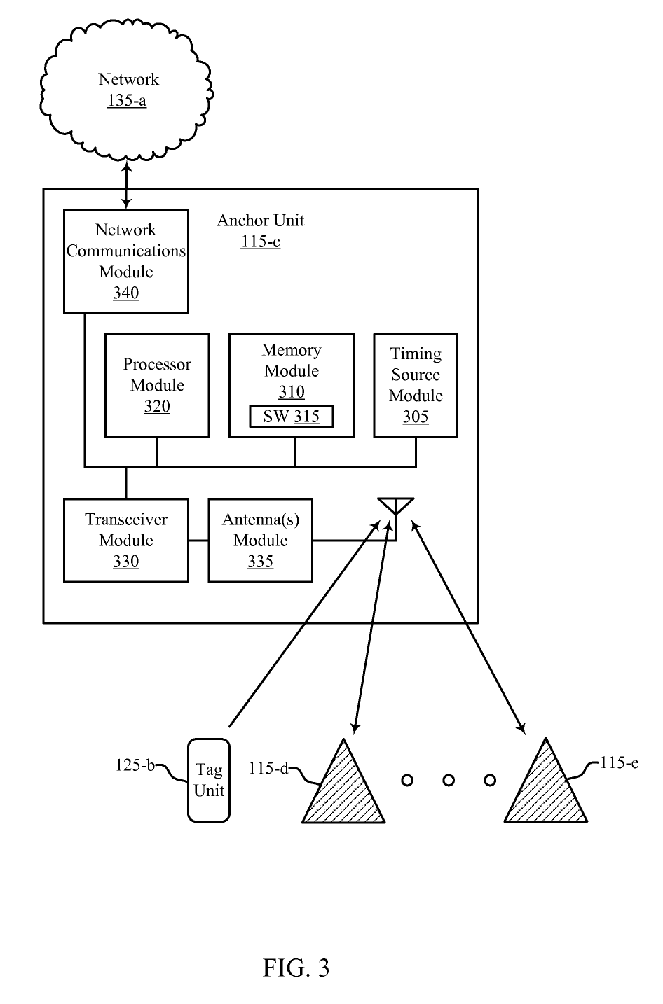

Turning to FIG. 3, an anchor unit 115-c is shown that may be an example of the anchor units 115, 115-a, and 115-b of FIG. 1 and FIG. 2. The anchor unit 115-c includes a timing source module 305, a memory module 310, a processor module 320, a transceiver module 330, antenna(s) module 335, and a network communications module 340. Each of these components may be in communication, directly or indirectly.

The timing source module 305 produces a clock and/or some other timing signal that is used by the anchor unit 115-c during operations. In some embodiments, the timing source 305 may include an oscillator and/or a frequency synthesizer that produces the appropriate clock for the operation of the anchor unit 115-c. The clock used by the anchor unit 115-c may be offset from the clock used by other anchor units and/or from the clock used by a tag unit such as the tag unit 125-a of FIG. 2. To compensate for the clock offset, particularly during range measurements used to determine the location of a tag unit, the anchor unit 115-c may send and/or receive information from other anchor units to determine the clock offset between the anchor unit 115-c and those other anchor units.

The memory module 310 may include random access memory (RAM) and read-only memory (ROM). The memory module 310 may also store computer-readable, computer-executable software (SW) code 315 containing instructions that are configured to, when executed, cause the processor module 320 to perform various functions described herein (e.g., range measurements, distance calculations, clock offset determination). Alternatively, the software code 315 may not be directly executable by the processor module 320 but be configured to cause the computer, e.g., when compiled and executed, to perform functions described herein.

The processor module 320 may include an intelligent hardware device, e.g., a central processing unit (CPU) such as those made by Intel® Corporation or AMD®, a microcontroller, an application-specific integrated circuit (ASIC), etc. The processor module 320 may perform various operations associated with synchronizing the anchor unit 115-c to other anchor units. For example, the processor module 320 may be used to generate data and prepare that data for transmission to another anchor unit to determine a clock offset between the anchor unit 115-c and the other anchor unit. The processor module 320 may use scheduling information received from, for example, the location tracking server 130, to determine which signals to generate and when to transmit the signals for determining a clock offset between the anchor unit 115-c and another anchor unit.

The transceiver module 330 may include a modem configured to modulate the data (e.g., packets) and provide the modulated data to the antenna(s) module 335 for transmission, and to demodulate data received from the antenna(s) module 335. While some examples of the anchor unit 115-c may include a single antenna, the anchor unit 115-c may include multiple antennas. As shown in FIG. 3, broadcast preamble signals transmitted from a tag unit 125-b may be received by the anchor unit 115-c through the antenna(s) in the antenna(s) module 335. Moreover, the anchor unit 115-c may wirelessly communicate with other anchor units such as anchor units 115-d through 115-e, for example. In some cases, the anchor unit 115-c may communicate with a network 135-a through the network communications module 340. The network 135-a may be an example of the network 135 of FIG. 1.

In some embodiments, the transceiver module 330 and/or the antenna(s) module 335 may support multiple RF communications technologies. For example, UWB communications as well as the unlicensed Industrial, Scientific, and Medical (ISM) band (e.g., 2.4 Gigahertz) communications may be concurrently supported by the transceiver module 330 and/or the antenna(s) module 335. UWB communications may be used to transmit/receive certain type of information between anchor units for clock offset determination while ISM band communications may be used to transmit/receive other type of information between anchor units for clock offset determination.

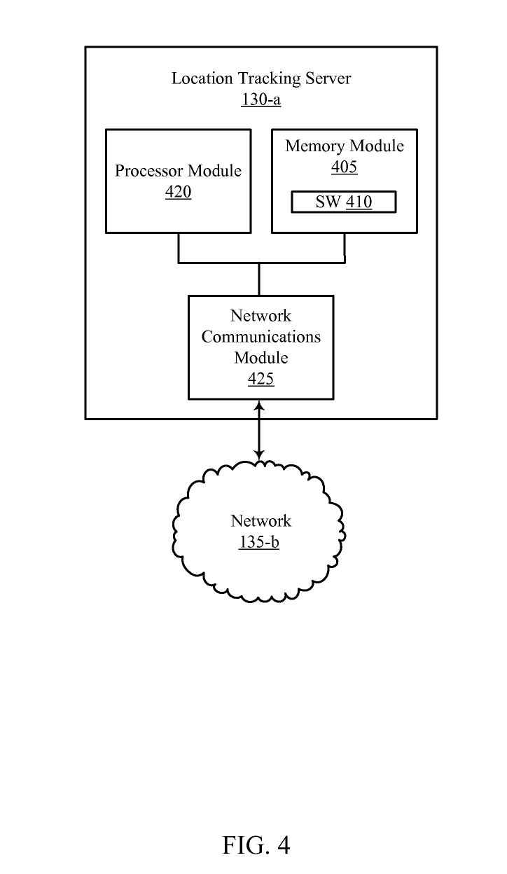

Turning to FIG. 4, a location tracking server 130-a is shown that may be an example of the location tracking server 130 of FIG. 1. The location tracking server 130-a includes a memory module 405, a processor module 420, and a network communications module 425. Each of these components may be in communication, directly or indirectly.

The memory module 405 may include RAM and ROM. The memory module 405 may also store computer-readable, computer-executable software code 410 containing instructions that are configured to, when executed, cause the processor module 310 to perform various functions described herein (e.g., range measurements, distance calculations, clock offset determination, transmission scheduling). Alternatively, the software code 410 may not be directly executable by the processor module 420 but be configured to cause the computer, e.g., when compiled and executed, to perform functions described herein.

The processor module 420 may include an intelligent hardware device, e.g., a CPU such as those made by Intel® Corporation or AMD®, a microcontroller, an ASIC, etc. The processor module 420 may perform various operations associated with synchronizing anchor units. For example, the processor module 420 may be used to schedule the transmission of data from one or more anchor units to one or more other anchor units to determine clock offsets. The processor module 420 may process information from one or more anchor units. For example, the processor module 420 may process information for range measurements, distance calculations, and clock offset determination. In some cases, the location tracking server 130-a may communicate with a network 135-b through the network communications module 425 to receive information from the anchor units and/or to send information to the anchor units. The network 135-b may be an example of the networks 135 and 135-a of FIG. 1 and FIG. 3, respectively.

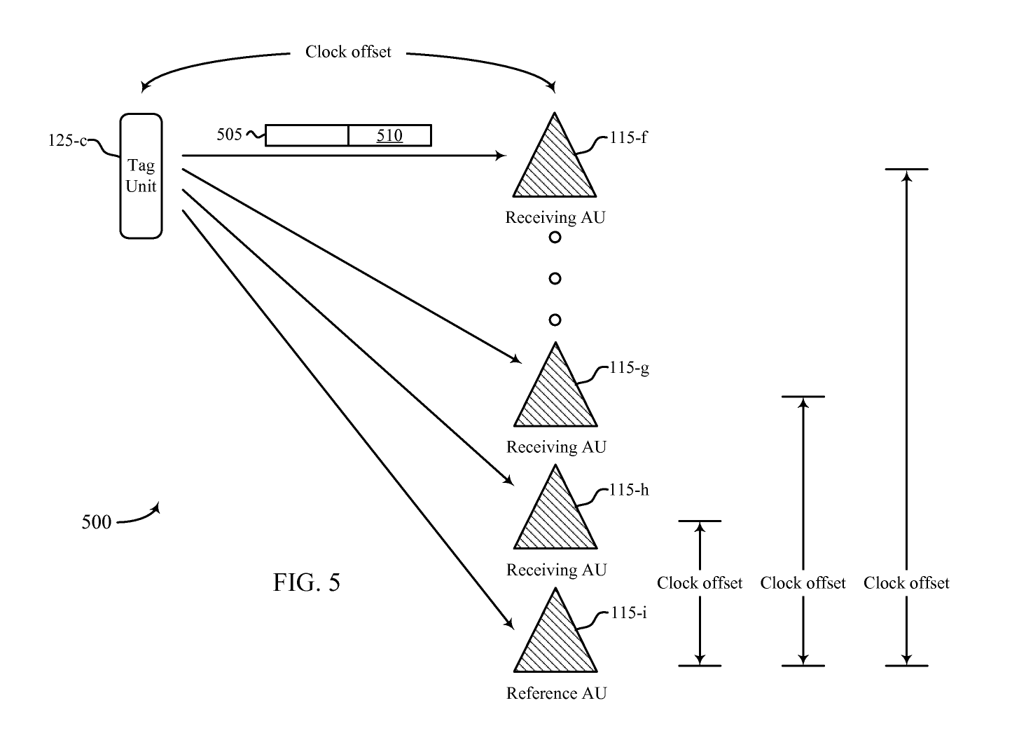

FIG. 5 shows a diagram 500 that illustrates clock offsets between a tag unit 125-c and anchor units 115-f, 115-g, 115-h, and 115-i. The tag unit 125-c may be an example of the tag units described above with reference to FIG. 1, FIG. 2, and FIG. 3. Similarly, the anchor units 115-f, 115-g, 115-h, and 115-i may be examples of the anchor units described above with reference to FIG. 1, FIG. 2, and FIG. 3. The tag unit 125-c may broadcast packets 505 that include a preamble 510 with information that identifies and/or distinguishes the tag unit 125-c from other tag units such that an asset or person attached to the tag unit 125-c may be independently tracked.

As noted above with reference to FIG. 2 and FIG. 3, the tag unit 125-c and the anchor units 115-f, 115-g, 115-h, and 115-i may each use their own timing source to produce a clock or some other timing signal for operations. The clocks, however, may be offset from each other. In some instances, the clocks may not run at the same frequency. For example, tag unit 125-c may have a clock offset with respect to the anchor unit 115-f, a clock offset with respect to the anchor unit 115-g, a clock offset with respect to the anchor unit 115-h, and a clock offset with respect to the anchor unit 115-I, which in this example is the reference anchor unit or R-AU. Similarly, the four anchor units shown in FIG. 5 may have clock offsets between them. FIG. 5 also shows that the clock offsets between the anchor units may be represented as clock offsets between of each of the anchor units 115-f, 115-g, and 115-h and the R-AU (i.e., anchor unit 115-i).

Each of the anchor units 115-f, 115-g, 115-h, and 115-i makes range measurements (e.g., pseudo-range measurements) to determine the distance between the anchor unit and the tag unit 125-c. These measurements are based on information included in the preambles 510 sent by the tag unit 125-c through the packets 505. The anchor units 115-f, 115-g, 115-h, and 115-i, or some other device (e.g., location tracking server 130), may use these measurements to estimate the location of the tag unit 125-c by triangulating or trilateration. An example of the type of calculations that may be used to determine the location of the tag unit 125-c is uplink-time difference of arrival (U-TDOA) in which the location is based on the time it takes for a signal to travel from the tag unit 125-c to each of the anchor units.

When the anchor units 115-f, 115-g, 115-h, and 115-i are not synchronized, that is, there are clock offsets between them, the clock offset associated with the tag unit 125-c relative to the R-AU affects the measurements that are made and, therefore, the overall estimate of the location of the tag unit 125-c. On the other hand, when the anchor units 115-f, 115-g, 115-h, and 115-i are synchronized, then the clock offset associated with the tag unit 125-c relative to the R-AU is removed from the triangulation calculations because the calculations implicitly use one additional measurement to estimate the clock offset associated with the tag unit 125-c. Therefore, to address or correct for the effect that the clock offset of the tag unit 125-c may have on estimating the location of the tag unit 125-c, the clocks of the various anchor units may be synchronized to that of the R-AU. The synchronization may include estimating the clock offsets between the anchor units and the R-AU and removing these clock offsets from the pseudo-range measurements prior to triangulation.

To synchronize the anchor units, the clock offsets between the different anchor units are determined or estimated. Once these estimates are made, the clock offset from each anchor unit to the R-AU may be calculated. There are two possible scenarios to consider. One in which the anchor unit synchronization involves determining the clock offset between a pair of anchor units with a clear line-of-sight (LOS) path between them and another that involves determining the clock offset between a pair of anchor units with an obstructed LOS path.

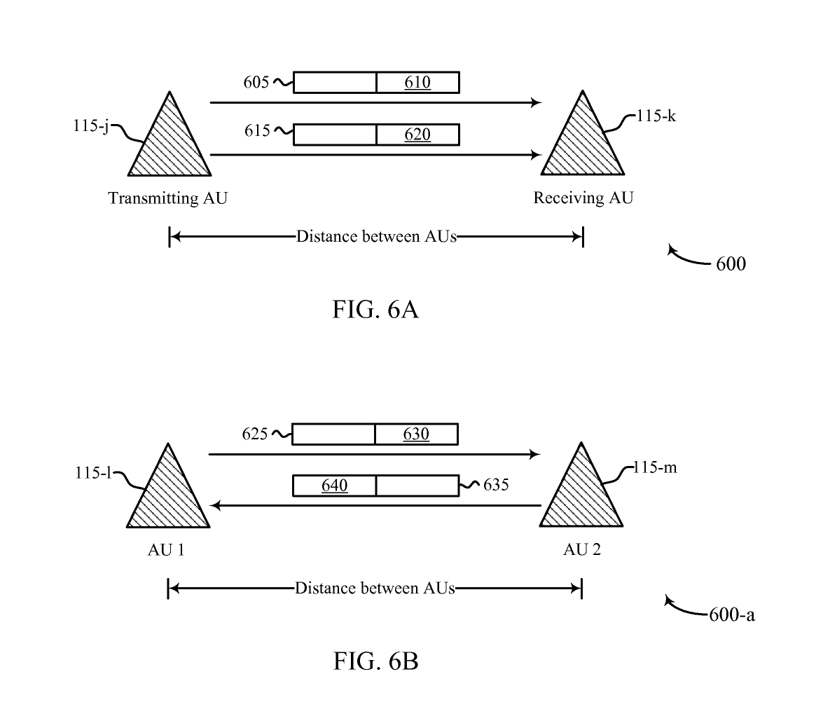

Turning now to FIG. 6A, a diagram 600 is shown that illustrates a first example of estimating the clock offset between two anchor units. In this example, there is a clear LOS path between an anchor unit 115-j and an anchor unit 115-k. The anchor units 115-j and 115-k may be examples of the anchor units described above with reference to FIG. 1, FIG. 2, FIG. 3, and FIG. 5. As noted above for the system 100 of FIG. 1, the locations of the anchor units are generally known because the anchor units are at specific locations in the indoor or enterprise environment in which they are deployed.

The clock offset between two anchor units may be estimated by having one anchor unit (e.g., anchor unit 115-j), the transmitting anchor unit or transmitting AU, send a packet 605 with a preamble 610 to the other anchor unit (e.g., anchor unit 115-k), the receiving anchor unit or receiving AU. The preamble 610 may be referred to as a ranging preamble, for example. The range (i.e., distance) between the two anchor units may be estimated based on a time of arrival of the preamble 610 at the receiving anchor unit. The transmitting anchor unit may also send to the receiving anchor unit the reference clock time corresponding to the first symbol in the packet 605. The reference clock time (i.e., timestamp) may be sent in a timing information portion 620 of a packet 615. In some embodiments, the receiving anchor unit may estimate the time of arrival of the packet 605 by estimating the time of arrival of the earliest path of the first symbol in the packet 605. The range is then estimated by comparing the arrival time of the earliest path to the time of transmission of the first symbol by the transmitting anchor unit that is stamped in the packet 615. Since the exact range between the two anchor units is known, then the clock offset between the two anchor units may be estimated from the difference between the exact range and the estimated range.

To get accurate clock offset estimates between the two anchor units, the preamble 610 (i.e., packet 605) may be sent on a wideband spectrum such as the one used for UWB. The link budget for UWB is typically poor because of low transmit power limit and, therefore, the packet (i.e., packet 615) carrying the timestamp information (i.e., timing information portion 620) may be sent on a spectrum and air interface that is different from UWB. A location tracking system, such as the system 100 of FIG. 1, may use one spectrum or frequency band (e.g., UWB spectrum) to send the ranging preamble, and another spectrum or frequency band (e.g., ISM band) to send data such as a timestamp. Therefore, the ranging preamble and the packet carrying the timestamp described above may be transmitted in two different bands.

With respect to FIG. 6B, a diagram 600-a is shown that illustrates a second example of estimating a clock offset between two anchor units. In this example, the clock offset between an anchor unit 115-1 (anchor unit 1 or AU 1) and an anchor unit 115-m (anchor unit 2 or AU 2) is estimated based on two-way time-of-flight measurements. In this example, like in the example of FIG. 6B, a clear LOS path exists between the two anchor units. The anchor units 115-1 and 115-m may be examples of the anchor units described above with reference to FIG. 1, FIG. 2, FIG. 3, FIG. 5, and FIG. 6A. As noted above for the system 100 of FIG. 1, the locations of the anchor units are generally known because the anchor units are at specific locations in the indoor or enterprise environment in which they are deployed. However, estimation of the clock offset based on two-way time-of-flight measurements need not require that the locations of the anchor units be known.

The two-way time-of-flight measurements include having the AU 1 send a preamble 630 in a packet 625 to AU 2 at a scheduled time. The scheduling of the transmission of the packet 625 may be provided by a location tracking server (e.g., location tracking server 130). After the preamble 630 is received, AU 2 may send a preamble 640 in a packet 635 back to AU 1. The preamble 630 may be sent to AU 1 a certain amount of time after the preamble 630 is received by AU 2. Both preambles may be sent using a wideband spectrum such as the one used for UWB. In some embodiments, AU 1 may determine the clock offset between AU 1 and AU 2 by obtaining a timestamp from AU 2 and subtracting the time of that timestamp from a time of a local timestamp. The timestamp received from AU 2 may be computed or determined by adding the time when AU 2 received the preamble 630 from AU 1 and the time when AU 2 sent the preamble 640 back to AU 1. The local timestamp at AU1 may be computed or determined by adding the time when AU 1 sent the preamble 630 to AU 2 and the time when AU 1 received the preamble 640 from AU 2. In other embodiments, the clock offset may be calculated by a different device such as a location tracking server. The approach described above may take twice as long to carry out compared to the clock offset estimate in the approach described in FIG. 6A.

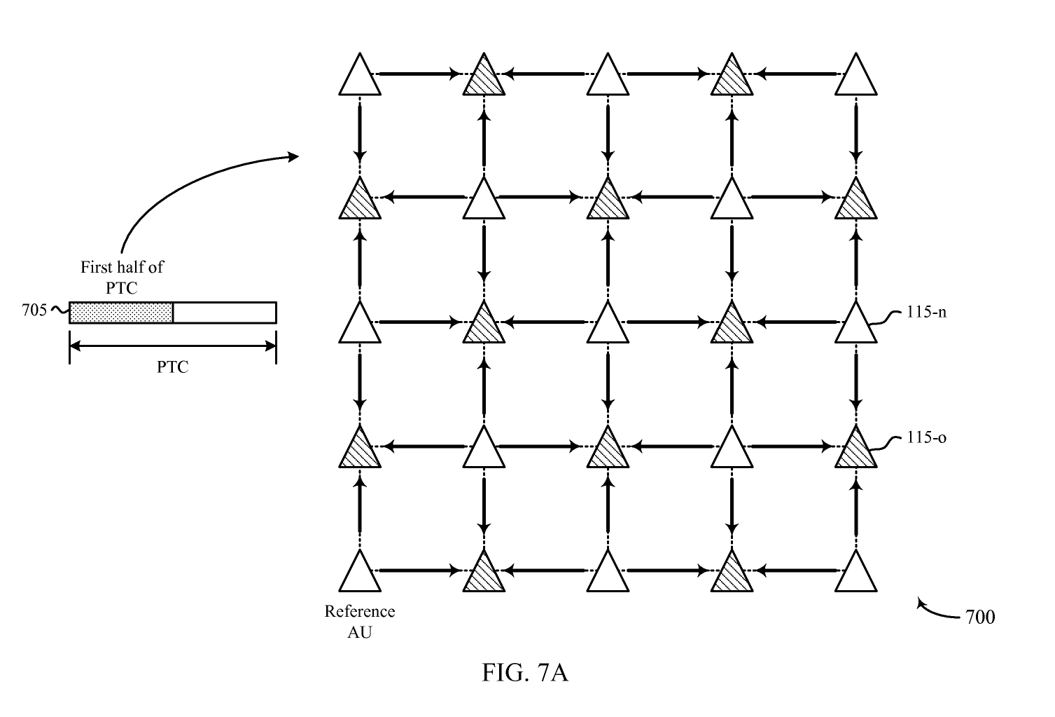

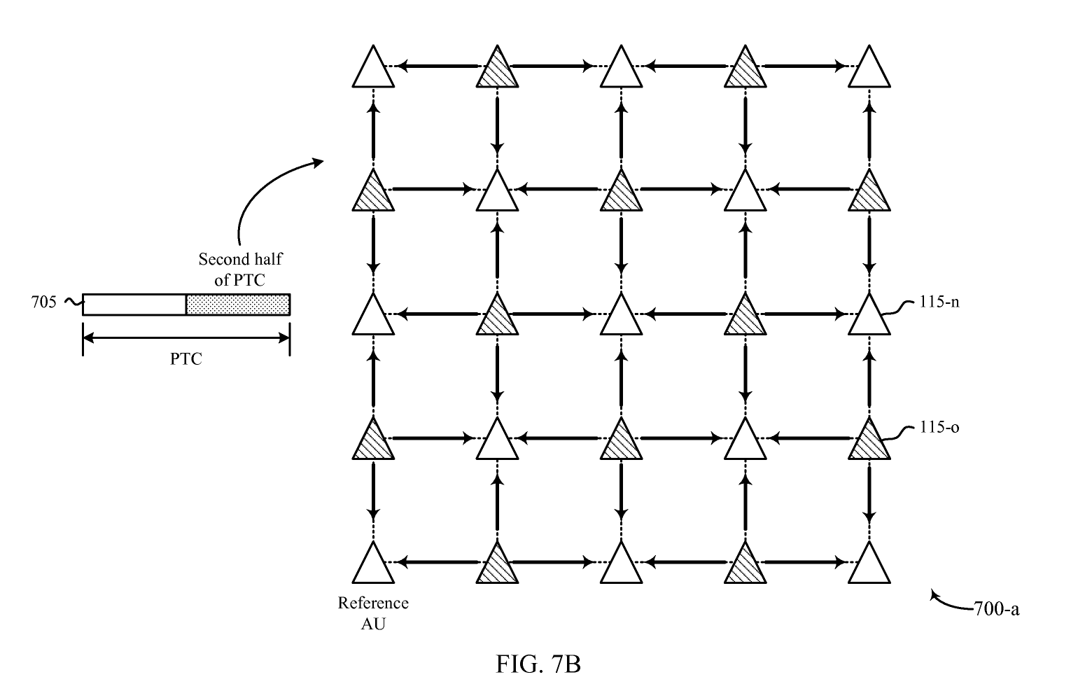

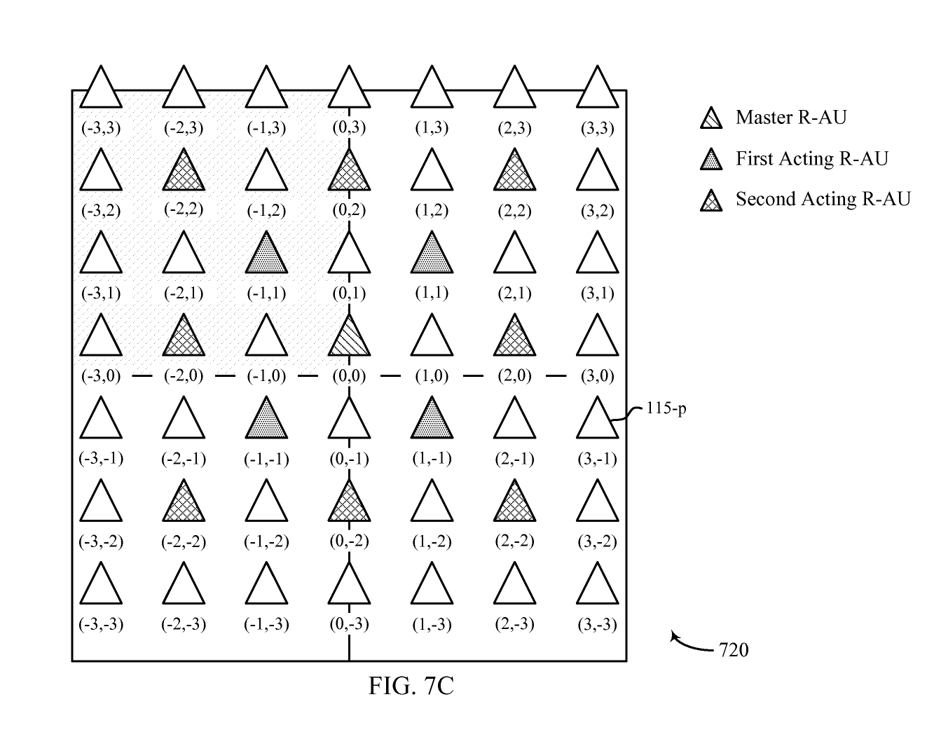

Turning to FIG. 7A, a diagram 700 illustrates a set of anchor units used in a location tracking system such as the system 100 of FIG. 1. The anchor units in the set may be examples of the anchor units described above with reference to FIG. 1, FIG. 2, FIG. 3, FIG. 5, FIG. 6A, and FIG. 6B. When using the method described above in FIG. 6B to update or revise the clock offset estimates between anchor units in the set, one approach is to break up the entire set of anchor units into two subsets and have the two subsets transmit and receive preambles alternatively. In the example illustrated by diagram 700, the first subset includes multiple anchor units 115-n (solid white) and the second subset includes multiple anchor units 115-o (diagonal lines). One of the anchor units 115-n is set as the reference anchor unit or R-AU.

A Preamble Transmission Cycle (PTC) 705 represents the time period when all the anchor units in the set have sent their preambles once. In the first half of the PTC 705, which is illustrated by the diagram 700, anchor units in the first subset of the anchor units (solid white) send their preambles and anchor units in the second subset of anchor units (diagonal lines) try to detect preambles from all their neighbors. In FIG. 7B, a diagram 700-a illustrates the set of anchor units of FIG. 7A during the second half of the PTC 705. In the second half of the PTC 705, anchor units in the second subset of the anchor units (diagonal lines) send their preambles and anchor units in the first subset of anchor units (solid white) try to detect preambles from all their neighbors. If the two subsets of transmitting and receiving anchor units are properly chosen as in FIG. 7A and FIG. 7B, then the anchor units may send and receive preambles during one PTC such that after that PTC all of the anchor units get to update their clock offsets with their neighboring anchor units.

One way to represent this process is through a connected graph. For example, a graph may be constructed that represents connections between an anchor unit and all of the neighboring anchor units with which that anchor unit has made two-way time-of-flight measurements. After one PTC, the graph may become a connected graph that may illustrate how clock offsets between the R-AU and the anchor units in the set may be estimated.

One approach that may be taken to estimate the clock offsets and compute the pseudo-ranges between tag units and anchor units is to complete one PTC and then have each tag unit send a preamble using different preamble codes and/or time slots. Because these transmissions are carried out within about 60 milliseconds −40 milliseconds for one PTC and another 20 milliseconds for the preamble transmissions from the tag units—the oscillators in the anchor units may be sufficiently stable. This stability allows for accurate range measurements to be made between the tag units and the anchor units and to accurately correct for clock offsets between the anchor units and the R-AU. In this approach, the preambles sent from the anchor units to other anchor units during the PTC and the preambles sent from the tag units to the anchor units during the range measurements may be transmitted using the same frequency band but different time slots.

In another approach, the preambles sent from the anchor units to other anchor units during the PTC may be sent using one frequency band, and the preambles sent from the tag units to the anchor units during the range measurements may be sent concurrently with the PTC using a different frequency band. This approach may reduce the time to estimate the clock offsets.

Turning now to FIG. 7C, a diagram 720 illustrates a network-wise time synchronization scheme for a network of anchor units 115-p used in a location tracking system such as the system 100 of FIG. 1. The anchor units in the network may be examples of the anchor units described above with reference to FIG. 1, FIG. 2, FIG. 3, FIG. 5, FIG. 6A, and FIG. 6B. In diagram 720, the schemes described above for achieving time synchronization between a pair of anchor units may be extended to achieve network-wise time synchronization, that is, to have the anchor units in the network to acquire timing of a reference anchor unit or R-AU.

For purposes of illustration, the anchor units 115-p in diagram 720 are shown as being uniformly placed on a rectangular grid. One of the anchor units is selected or determined to be the R-AU. Without loss of generality, the anchor unit at position (0,0) (diagonal lines) is the one selected or determined to be the R-AU. The R-AU then broadcasts a preamble over a wideband channel (e.g., UWB) followed by the preamble transmission timestamp, where the transmission timestamp may be derived or determined from a counter in the R-AU running at a Gigahertz (GHz) sampling clock. In some embodiments, instead of sending the transmission timestamp over the same wideband channel used to broadcast the preamble, the transmission timestamp may be sent over a narrowband channel as described above with reference to FIG. 6A. Additionally or alternatively, the transmission of the timestamp may be avoided in at least some instances by having the R-AU broadcast the probe signals (e.g., preambles) at fixed or specified times that are known a priori by the anchor units receiving the broadcast signals. The times at which the broadcasts are made may be based on the R-AU local clock, which is typically also the global clock.

Each of the anchor units 115-p that receives the preamble from the R-AU may estimate the arrival time of the preamble and compute its time offset with respect to the R-AU since the transmission timestamp and the distance between pairs of anchor units in the network may be known. For example, the distance between any pair of anchor units in the network may be determined using ranging measurements during the installation of the anchor units. The anchor unit then performs the time correction and sends an acknowledgment indication (e.g., ACK message) to the R-AU over the narrowband channel to notify the R-AU that the anchor unit is able to acquire fine timing (i.e., fine synchronization) from the R-AU. From the ACK messages received over the narrowband channel, the R-AU may form a set or list that includes the anchor units that are capable of achieving direct synchronization with the R-AU.

After an anchor unit achieves fine synchronization with the R-AU, it can take the role of Acting R-AU for the purpose of synchronizing other anchor units that are within its range. This role may be taken if directed to do so by the R-AU or by a server (e.g., location tracking server 130). The decision to designate an anchor units as the Acting R-AU may be based on maximizing the number of anchor units in the network that are not yet synchronized, and that may be potentially synchronized, by having an anchor unit designated in that manner. The designation of anchor units as Acting R-AUs may be repeated until the network-wise fine synchronization is achieved. For example, an anchor unit that is synchronized with an Acting R-AU may itself be designated as an Acting R-AU for synchronizing other anchor units. At the end of the process, the R-AU has the information about the number of Acting R-AUs and a list of anchor units that acquired timing from a particular Acting R-AU. This information may be used by the R-AU for tracking fine timing.

In an example that illustrates of the network-wise synchronization scheme described above, the anchor units 115-p are placed or organized in the rectangular grid of FIG. 7C, with a unit distance between any two anchor units and a master R-AU (diagonal lines) located at position (0,0). Any anchor unit in diagram 720 is able to communicate with its eight nearest neighbors. It is understood that in other examples the anchor units 115-p need not be organized in a rectangular grid, the anchor units 115-p may have different distances between them, the master R-AU need not be located at position (0,0), and/or each of the anchor units 115-p may have the ability to communicate with more or fewer than eight other anchor units 115-p in the network.

Returning to the example of the network-wise synchronization scheme, the Master R-AU communicates with its eight nearest neighbors, which are listed in Table 1. One or more of those neighbors may be designated as Acting R-AU for subsequent synchronizations. In this example, the neighbor anchor units located at positions (−1,1), (1,1), (−1,−1), and (1,−1) have been designated as Acting R-AUs (dotted shading). Because these are the first group of Acting R-AUs designated in the network-wise synchronization scheme, they may be referred to as First Acting R-AUs. To simplify the example, only the anchor units in the top-right (i.e., first) quadrant of the network in diagram 720 are considered next. As noted above, the anchor unit located at position (1,1) has been designated as an Acting R-AU or First Acting R-AU. This anchor unit may communicate with its eight nearest neighbors and synchronize those neighbors. Of the eight neighbors of the anchor unit at position (1,1), three have already been synchronized to the Master R-AU since they are also part of the eight nearest neighbors of the Master R-AU. The remaining five nearest neighbors to the anchor unit at position (1,1) are listed in Table 1. Of these remaining five nearest neighbors, one or more may be designated Acting R-AUs for subsequent synchronizations. In this example, the neighbor anchor units located at positions (0,2), (2,2), and (2,0) have been designated as Acting R-AUs (cross-hatch). Because these anchor units are part of a second group of Acting R-AUs designated in the network-wise synchronization scheme, these anchor units may be referred to as Second Acting R-AUs. The nearest neighbors to the Second Acting R-AUs that are synchronized by those anchor units are shown in Table 1. It will be understood that the same approach as described above may be applied to the anchor units in the other quadrants (e.g., top-left quadrant, bottom-left quadrant, or bottom-right quadrant) of the rectangular grid in diagram 720. In some embodiments, more than one Acting R-AUs may be able to synchronize an anchor unit and the Master R-AU and/or a server (e.g., location tracking server 130) may select which of the Acting R-AUs is to synchronize the anchor unit.

TABLE 1

| Master R-AU/ | |
|---|---|
| Acting R-AU | Anchor Units Synchronized |
| (0, 0) | (1, 0), (1, 1), (0, 1), (−1, 1), (−1, 0), (−1, −1), (0, −1), |
| | (1, −1) |
| (1, 1) | (2, 1), (2, 2), (1, 2), (2, 0), (0, 2) |
| (2, 2) | (3, 1), (3, 2), (3, 3), (2, 3), (1, 3) |
| (2, 0) | (3, 0) |
| (0, 2) | (0, 3) |

After the network-wise initial synchronization is achieved or completed as described above, tracking may be performed. Tracking may involve having the Master R-AU periodically broadcast preambles or probes in the wideband channel (e.g., UWB). The preambles may be broadcast once every few seconds at a scheduled time, for example. Each of the anchor units in the network that is designated as an Acting R-AU and receives the preambles from the Master R-AU may need to rebroadcast the preambles. The rebroadcasting may take place at a scheduled or specified time. The process continues until all the anchor units have received a preamble. Then each anchor unit processes the preamble to compute its timing offset with respect to the Master R-AU and/or to any of the Acting R-AUs between the Master R-AU and the anchor unit that participated in the preamble rebroadcasting process.

In some embodiments, one or more anchor units may synchronize their clocks to a Global Positioning System (GPS) signal by deploying some of the anchor units to locations where those anchor units may receive GPS signals. For example, some of the anchor units may be placed near windows or other openings to allow the anchor units to more effectively receive the GPS signals. The remaining anchor units, that is, those that are unable to receive GPS signals for synchronization, may synchronize their clocks by using one or more of the methods described herein.

In the various clock offset estimation and/or synchronization schemes described above, it is generally considered that the line-of-sight (LOS) path between any two anchor units is clear. In other words, the receiving anchor unit receives a signal (e.g., preamble) from the transmitting anchor unit along a direct signal path and not through a multipath. But in some cases, the LOS path between the two anchor units is blocked due to obstructions and the receiving anchor unit receives the preamble via a reflection, that is, via a multipath. When this occurs, the two-way time-of-flight measurement may be overestimated because of the extra distance that a signal has to travel to reach the receiving anchor unit. The clock offset that is then calculated by comparing the two-way time-of-flight to the true distance between the two anchor units includes extra time because of the difference in the distance that the signal travels between the clear LOS path and the multipath. Therefore, when correcting for clock offsets, a distinction is to be made between the clock offset due to the clock oscillator or frequency synthesizer in the anchor unit and the clock offset caused by an obstructed LOS path.

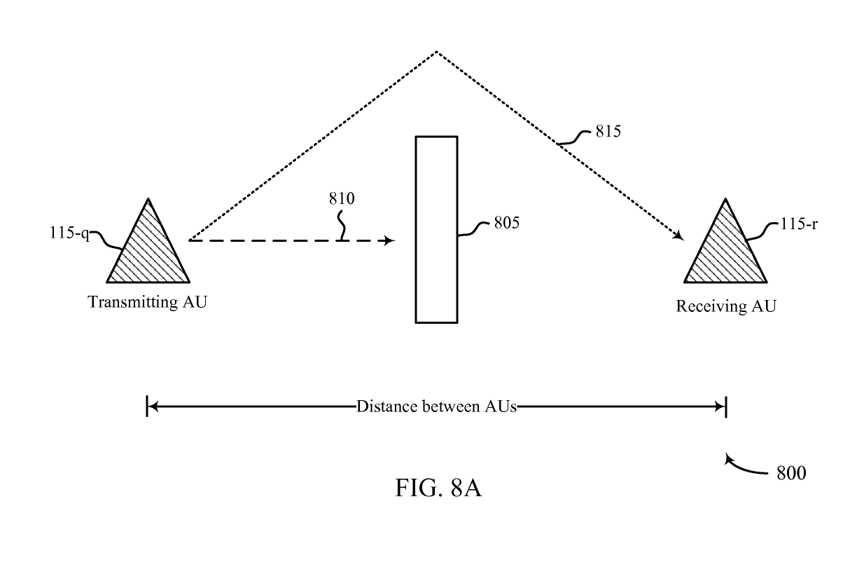

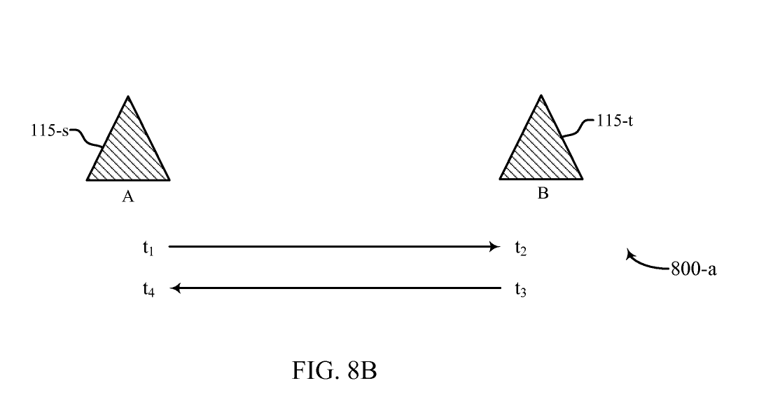

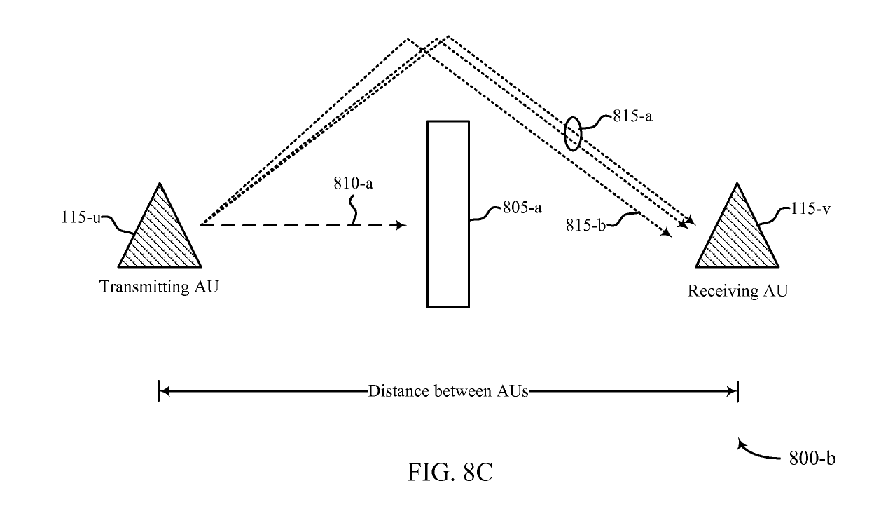

Turning to FIG. 8A, a diagram 800 illustrates the situation described above in which a LOS path 810 between a transmitting anchor unit (anchor unit 115-q) and a receiving anchor unit (anchor unit 115-r) is blocked by an object 805 such that only multipaths (e.g., multipath 815) are possible for a transmission to reach the receiving anchor unit. The anchor units 115-q and 115-r may be examples of anchor units described above with reference to FIG. 1, FIG. 2, FIG. 3, FIG. 5, FIG. 6A, FIG. 6B, FIG. 7A, FIG. 7B, and FIG. 7C. When the LOS path 810 is blocked, there may be four sources of error. The first source is the frequency offset, Fₒ, between the oscillators or frequency synthesizers of the anchor units 115-q and 115-r. A typical frequency offset is measured in parts per million or ppm. The second source is the clock timing offset caused by the oscillator frequency variation due to Allan variance, Tₐᵥ. Allan variance is typically a measure of the stability of a clock or oscillator. The Allan variance may be approximately modeled by a zero mean random variable and may need to be corrected every few hundred milliseconds, for example. The third source is the average timing sampling bias, T_{b}, caused by the LOS path 810 being blocked and is the time difference between the LOS path 810 and the multipath 815 that the receiving anchor unit (anchor unit 115-r) has locked onto. The forth source of error is the clock time offset of a given AU with respect to the reference AU denoted by Tₒ.

To address the blocked LOS path in determining the appropriate clock offset between the anchor units 115-p and 115-q, the four sources of error described above need to be estimated and corrected. The first source, Fₒ, may be estimated by sending a pilot signal from the anchor unit 115-p to the anchor unit 115-q, and have the anchor unit 115-q (receiving anchor unit) estimate Fₒ from the pilot signal. In some instances, a wideband spectrum such as the one used for UWB may be used to send the pilot signal. In other instances, a frequency band or spectrum different from that used for UWB may be used to send the pilot signal. The anchor unit 115-q may then adjust its frequency synthesizer to correct for Fₒ. The estimation and correction of Fₒ may be carried out by using one of the schemes described above for when the LOS path is not obstructed. Fₒ may be estimated periodically at a low rate (e.g., every few minutes) to track changes due to temperature and equipment aging, and need not be done with every range measurement.

After correcting for the frequency offset, the clock offset, Tₒ, between the anchor units 115-q and 115-r may be estimated by making measurements as described above with reference to FIG. 6B, FIG. 7A, FIG. 7B, and FIG. 7C, for example, while removing/correcting the terms due to propagation bias, T_{b}, or Allan variance, Tₐᵥ.

Turning next to FIG. 8B, a diagram 800-a illustrates an example of estimating the clock offset, Tₒ. In this example, there is an anchor unit 115-s, or anchor unit A, and an anchor unit 115-t, or anchor unit B. The direct path between the two anchor units may be referred to as the direct path time-of-flight or TOF. The anchor unit A may send or transmit a packet to the anchor unit B at time t₁ and the packet is received by the anchor unit B at a time t₂. The anchor unit B sends back the packet to the anchor unit A at a time t₃, and the packet is received by the anchor unit A at a time t₄. As described above, T_{b} refers to the additional time-of-flight in case the LOS path between two anchor units is not available, and Tₒ is the clock time offset between the two anchor units. Accordingly, the following expressions may be used to relate the transmission and arrival of packets between the anchor units A and B in FIG. 8B:

t₂=t₁+TOF+T_{b}+Tₒ, and (1)

t₄=t₃+TOF+T_{b}−Tₒ. (2)

By using two-way transmissions between the anchor units A and B as described above, the clock offset Tₒ may be given by the following expression:

Tₒ=[(t₂+t₃)−(t₁+t₄)]/2. (3)

As can be seen from equation (3), the estimation of Tₒ may be independent of the propagation path between anchor units A and B whether or not the path is LOS or the LOS is blocked.

Turning now to FIG. 8C, a diagram 800-b illustrates the situation in which a LOS path 810-a between a transmitting anchor unit (anchor unit 115-u) and a receiving anchor unit (anchor unit 115-v) is blocked by an object 805-a such that only multipaths (e.g., multipaths 815-a and 815-b) reach the receiving anchor unit. Diagram 800-b illustrates another issue that arises when the LOS path 810-a is blocked. When two multipaths are closer to each other than a waveform duration, as is the case with multipath 815-a, then the two multipaths are not resolvable. The sum of these two multipaths may be referred to as a fat path. If the time where the highest energy is received from a fat path is sampled, then the sampling time may be different from the time of arrival of the earlier of the two multipaths that make up the fat path. In other words, the center of energy of the fat path, which may be different from the time of arrival of the earlier path, may cause a timing offset error which may be difficult to estimate. Because the phases of two multipaths that make up the fat path may change with time, the center of energy of the fat path may also change with time and the timing offset caused by the fat path may change even between measurements causing some residual error.

One way to minimize the effect of fat path is to search for the earliest “clean” multipath which is not a fat path and use this path for estimating timing offset. Diagram 800-b shows s multipath 815-b as the earliest “clean” multipath that is not the multipath 815-a (i.e., fat path). Then, T_{b}, may be accurately estimated using, for example, one or more of the schemes described above while removing the error terms resulting from the propagation and the Allan variance as described above.

Another aspect to consider is that in a typical location tracking system (e.g., system 100), most of the anchor units have a clear LOS path between them and only very few anchor units have their LOS path blocked. In such instances, it may be possible to synchronize the clocks of the anchor units to a reference anchor unit or R-AU by using a signal path between anchor units which have a clear LOS path present. In one approach, the links between anchor units that have a clear LOS path may be identified to construct a graph of links between anchor units that are marked as having a clear LOS path. If this graph is fully connected to the reference anchor unit, then it may be possible to use the anchor unit synchronization schemes that work for LOS paths, such as the one described in FIG. 7C, for example, which does not correct for the timing offset, T_{b}, due to blockage.

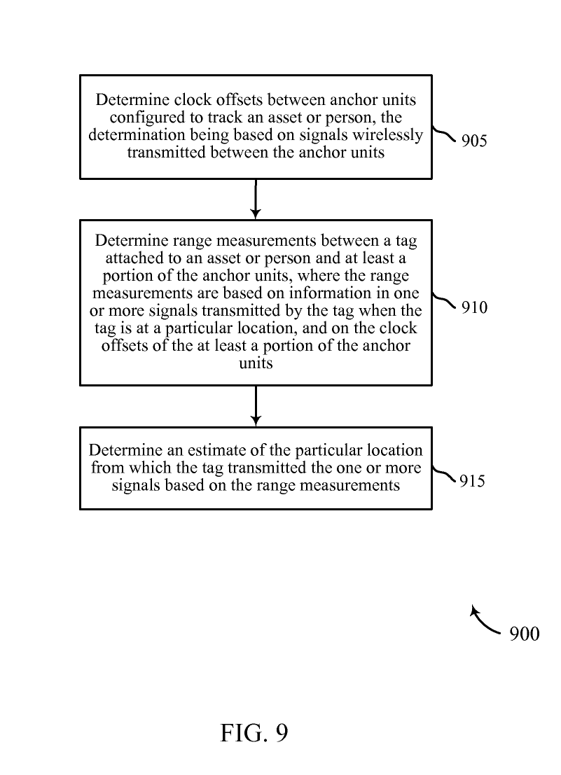

Turning to FIG. 9, a flowchart diagram of an example method 900 for location tracking. The method 900 may be performed using, for example, the system 100 of FIG. 1; the tag units 125, 125-a, 125-b, and 125-c of FIG. 1, FIG. 2, FIG. 3, and FIG. 5, respectively; the anchor units 115 of FIG. 1 and other similar anchor units described above with reference to FIG. 2, FIG. 3, FIG. 5, FIG. 6A, FIG. 6B, FIG. 7A, FIG. 7B, FIG. 7C, FIG. 8A, FIG. 8B, and FIG. 8C; and/or the location tracking servers 130 and 130-a of FIG. 1 and FIG. 4, respectively.

At block 905, clock offsets are determined between anchor units configured to track an asset or person, where the determination is based on signals wirelessly transmitted between the anchor units. At block 910, range measurements are determined between a tag (e.g., tag unit 125) attached to an asset or person and at least a portion of the anchor units, where the range measurements are based on information in one or more signals transmitted by the tag when the tag is at a particular location, and on the clock offsets of the at least a portion of the anchor units. At block 915, an estimate of the particular location from which the tag transmitted the one or more signals is determined based on the range measurements.

In some embodiments of the method 900, an estimate of the distance between a first anchor unit of the anchor units and a second anchor unit of the anchor units is determined, where the distance estimate is based on two-way time-of-flight information between the first anchor unit and the second anchor unit. The clock offset between the first anchor unit and the second anchor unit is determined based on the distance estimate.

In some embodiments of the method 900, a first portion, group, or subset of the anchor units and a second portion, group, or subset of the anchor units different from the first group are identified. The wireless transmission of ranging information from anchor units in the first group to anchor units in the second group during a first period of time are scheduled as well as from anchor units in the second group to anchor units in the first group during a second period of time subsequent to the first period of time. The clock offsets between the anchor units are determined based on two-way time-of-flight information resulting from the transmission of ranging information during the first period of time and during the second period of time. The ranging information transmitted during the first period of time and during the second period of time is transmitted using a first frequency spectrum, while the one or more signals transmitted by the tag are transmitted using a second frequency spectrum different from the first frequency spectrum.

In some embodiments of the method 900, one of the anchor units is identified as a reference anchor unit, and a clock offset between each of the other anchor units and the reference anchor unit is determined based on the clock offsets between the anchor units.

In some embodiments of the method 900, determining the clock offsets between anchor units includes determining an estimate of the distance between a first anchor unit of the anchor units and a second anchor unit of the anchor units, where the distance estimate is based on information in a packet received by the second anchor unit from the first anchor unit, and also determining the clock offset between the first anchor unit and the second anchor unit based on the distance estimate. The packet information may include a timestamp that indicates a time of transmission of the packet from the first anchor unit. The packet information includes a ranging preamble which may be configured to determine a time of arrival of the packet at the second anchor unit. The packet may be received by the second anchor unit via a first frequency spectrum, in which case the information in the packet includes a ranging preamble configured to determine a time of arrival of the packet at the second anchor unit, while a timestamp may be received by the second anchor unit via a second frequency spectrum different from the first frequency spectrum, in which case the timestamp indicates a time of transmission of the packet from the first anchor unit. A time of arrival of the packet at the second anchor unit may be determined based on a ranging preamble in the packet information, and the distance estimate may be determined based on the time of arrival of the packet.

In some embodiments of the method 900, packets may be sent between a first anchor unit of the anchor units and a second anchor unit of the anchor units, wherein a timing of the sending of the packets and a timing of the receiving of the packets are utilized to determine the clock offset between the first anchor unit and the second anchor unit when a line-of-sight (LOS) between the first anchor unit and the second anchor unit is blocked.

In some embodiments of the method 900, a subset of the anchor units that do not have a main path between two anchor units blocked is identified, and the clock offsets between anchor units are determined from the subset of the anchor units.

In some embodiments of the method 900, one of the anchor units may be identified as a master reference anchor unit, one or more of the remaining anchor units may be synchronized to the master reference anchor unit, and at least one of the one or more of anchor units synchronized to the master reference anchor unit may be identified as an acting reference anchor unit. An additional at least one acting reference unit may be identified from the one or more anchor units synchronized to the at least one acting reference anchor unit

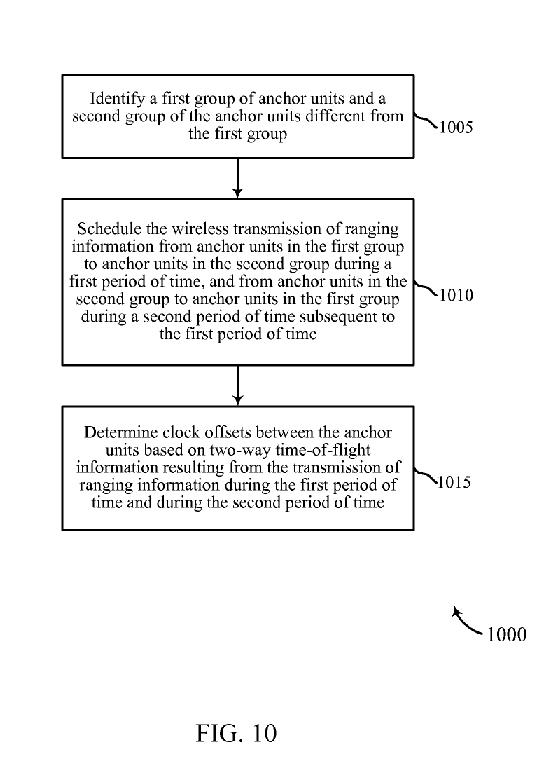

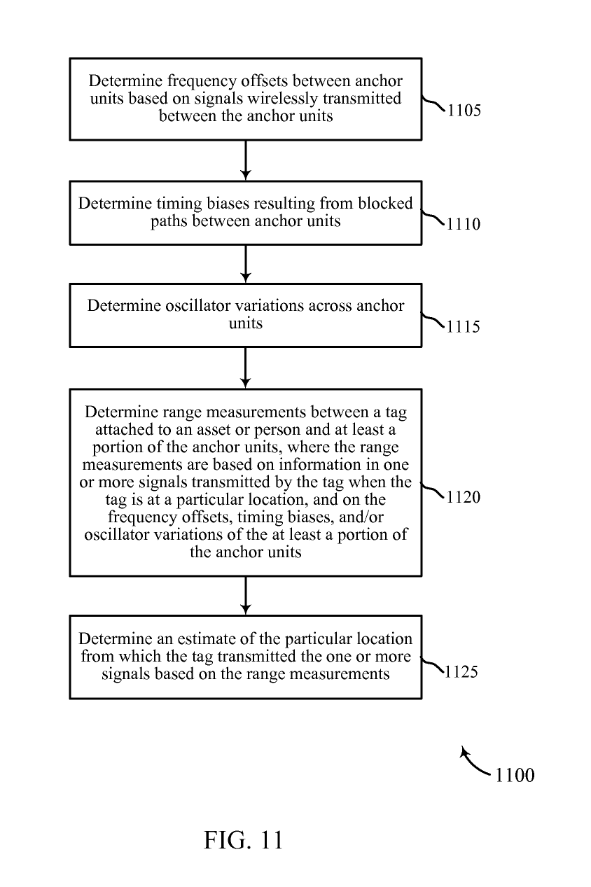

Turning to FIG. 10, a flowchart diagram of an example method 1000 for location tracking. The method 1000, like the method 900 above, may be performed using, for example, the system 100 of FIG. 1; the tag units 125, 125-a, 125-b, and 125-c of FIG. 1, FIG. 2, FIG. 3, and FIG. 5, respectively; the anchor units 115 of FIG. 1 and other similar anchor units described above with reference to FIG. 2, FIG. 3, FIG. 5, FIG. 6A, FIG. 6B, FIG. 7A, FIG. 7B, FIG. 7C, FIG. 8A, FIG. 8B, and FIG. 8C; and/or the location tracking servers 130 and 130-a of FIG. 1 and FIG. 4, respectively.

At block 1005, a first portion, group, or subset of anchor units and a second portion, group, or subset of the anchor units may be identified, where the second group is different from the first group. At block 1010, wireless transmissions of ranging information from anchor units in the first group to anchor units in the second group during a first period of time (e.g., one half of a PTC) may be scheduled. Also scheduled may be wireless transmissions of ranging information from anchor units in the second group to anchor units in the first group during a second period of time (e.g., another half of the PTC) subsequent to the first period of time. At block 1015, the clock offsets between the anchor units may be determined based on two-way time-of-flight information resulting from the transmission of ranging information during the first period of time and during the second period of time.

Turning to FIG. 11, a flowchart diagram of an example method 1100 for location tracking. The method 1100, like the methods 900 and 1000, may be performed using, for example, the system 100 of FIG. 1; the tag units 125, 125-a, 125-b, and 125-c of FIG. 1, FIG. 2, FIG. 3, and FIG. 5, respectively; the anchor units 115 of FIG. 1 and other similar anchor units described above with reference to FIG. 2, FIG. 3, FIG. 5, FIG. 6A, FIG. 6B, FIG. 7A, FIG. 7B, FIG. 7C, FIG. 8A, FIG. 8B, and FIG. 8C; and/or the location tracking servers 130 and 130-a of FIG. 1 and FIG. 4, respectively.

At block 1105, frequency offsets between anchor units are determined based on signals wirelessly transmitted between the anchor units. At block 1110, timing biases resulting from blocked paths between anchor units may be determined. At block 1115, oscillator variations across anchor units may be determined.

At block 1120, range measurements are determined between a tag (e.g., tag unit 125) attached to an asset or person and at least a portion of the anchor units, where the range measurements are based on information in one or more signals transmitted by the tag when the tag is at a particular location, and on the frequency offsets, the timing biases, and/or the oscillator variations of the at least a portion of the anchor units. At block 1125, an estimate of the particular location from which the tag transmitted the one or more signals is determined based on the range measurements.

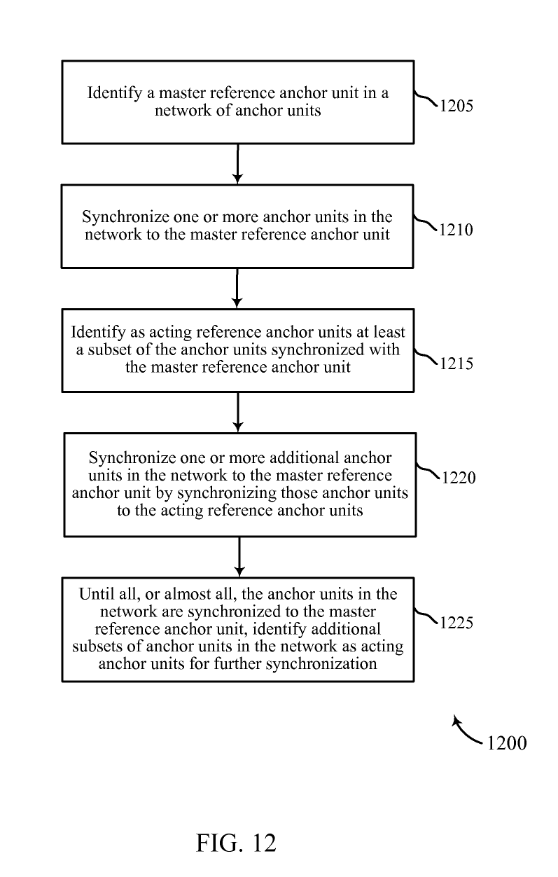

Turning to FIG. 12, a flowchart diagram of an example method 1200 for a network-wise time synchronization scheme for anchor units. The method 1200 may be performed using, for example, the system 100 of FIG. 1; the anchor units 115 of FIG. 1 and other similar anchor units described above with reference to FIG. 2, FIG. 3, FIG. 5, FIG. 6A, FIG. 6B, FIG. 7A, FIG. 7B, FIG. 7C, FIG. 8A, FIG. 8B, and FIG. 8C; and/or the location tracking servers 130 and 130-a of FIG. 1 and FIG. 4, respectively.

At block 1205, a master reference anchor unit, or Master R-AU, may be identified in a network of anchor units. At block 1210, one or more anchor units in the network may be synchronized to the master reference anchor unit. At block 1215, at least a subset of the anchor units synchronized to the master reference anchor unit may be identified as acting reference anchor units, or Acting R-AUs. At block 1220, one or more additional anchor units in the network may be synchronized to the master reference anchor unit by synchronizing those anchor units to the acting reference anchor units. At block 1225, until all, or almost all, the anchor units in the network are synchronized to the master reference anchor unit, additional subsets of anchor units in the network may be identified as acting reference anchor units for further synchronization. In some embodiments, a threshold number or percentage of synchronized anchor units may be used to determine when the network is considered to be synchronized or mostly synchronized. Those anchor units not synchronized may be known by the master reference anchor unit or a server (e.g., location tracking server 130) and may be handled separately and/or differently from the anchor units that are synchronized.

Techniques described herein may be used in connection with various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for location tracking, comprising:
determining clock offsets between anchor units configured to track an asset or person, the determination being based on signals wirelessly transmitted between the anchor units;
determining range measurements between a tag attached to the asset or person and at least a portion of the anchor units, wherein the range measurements are based on information in one or more signals transmitted by the tag when the tag is at a particular location, and on the clock offsets of the at least a portion of the anchor units; and
determining an estimate of the particular location from which the tag transmitted the one or more signals based on the range measurements.

2. The method of claim 1, wherein determining the clock offsets between anchor units comprises:
determining an estimate of the distance between a first anchor unit of the anchor units and a second anchor unit of the anchor units, the distance estimate being based on two-way time-of-flight information between the first anchor unit and the second anchor unit; and
determining the clock offset between the first anchor unit and the second anchor unit based on the distance estimate.

3. The method of claim 1, further comprising:
identifying a first group of the anchor units and a second group of the anchor units different from the group portion;
scheduling the wireless transmission of ranging information from anchor units in the first group to anchor units in the second group during a first period of time, and from anchor units in the second group to anchor units in the first group during a second period of time subsequent to the first period of time; and
determining the clock offsets between the anchor units based on the two-way time-of-flight information resulting from the transmission of ranging information during the first period of time and during the second period of time.

4. The method of claim 3, wherein:
the ranging information transmitted during the first period of time and during the second period of time is transmitted using a first frequency spectrum, and
the one or more signals transmitted by the tag are transmitted using a second frequency spectrum different from the first frequency spectrum.

5. The method of claim 1, further comprising:
identifying one of the anchor units as a reference anchor unit; and
determining a clock offset between each of the other anchor units and the reference anchor unit based on the clock offsets between the anchor units.

6. The method of claim 1, wherein determining the clock offsets between anchor units comprises:
determining an estimate of the distance between a first anchor unit of the anchor units and a second anchor unit of the anchor units, the distance estimate being based on information in a packet received by the second anchor unit from the first anchor unit; and
determining the clock offset between the first anchor unit and the second anchor unit based on the distance estimate.

7. The method of claim 6, wherein the packet information includes a timestamp that indicates a time of transmission of the packet from the first anchor unit.

8. The method of claim 6, wherein the packet information includes a ranging preamble configured to determine a time of arrival of the packet at the second anchor unit.

9. The method of claim 6, wherein:
the packet is received by the second anchor unit via a first frequency spectrum, the information in the packet including a ranging preamble configured to determine a time of arrival of the packet at the second anchor unit; and
a timestamp is received by the second anchor unit via a second frequency spectrum different from the first frequency spectrum, the timestamp indicating a time of transmission of the packet from the first anchor unit.

10. The method of claim 6, further comprising:
determining a time of arrival of the packet at the second anchor unit based on a ranging preamble in the packet information; and
determining the distance estimate based on the time of arrival of the packet.

11. The method of claim 1, wherein determining the clock offsets between anchor units comprises:
sending packets between a first anchor unit of the anchor units and a second anchor unit of the anchor units, wherein a timing of the sending of the packets and a timing of the receiving of the packets are utilized to determine the clock offset between the first anchor unit and the second anchor unit when a line-of-sight between the first anchor unit and the second anchor unit is blocked.

12. The method of claim 1, further comprising:
identifying a subset of the anchor units that do not have a main path between two anchor units blocked; and
determining the clock offsets between anchor units from the subset of the anchor units.

13. The method of claim 1, wherein determining the clock offsets between anchor units comprises:
identifying one of the anchor units as a master reference anchor unit;
synchronizing the master reference anchor unit to one or more of the remaining anchor units; and
identifying at least one acting reference anchor unit from the one or more of anchor units synchronized to the master reference anchor unit.

14. The method of claim 13, wherein determining the clock offsets between anchor units further comprises:
identifying an additional at least one acting reference unit from one or more anchor units synchronized to the at least one acting reference anchor unit.

15. A location tracking system, comprising:
means for determining clock offsets between anchor units configured to track an asset or person, the determination being based on signals wirelessly transmitted between the anchor units;
means for determining range measurements between a tag attached to the asset or person and at least a portion of the anchor units, wherein the range measurements are based on information in one or more signals transmitted by the tag when the tag is at a particular location, and on the clock offsets of the at least a portion of the anchor units; and
means for determining an estimate of the particular location from which the tag transmitted the one or more signals based on the range measurements.

16. The system of claim 15, wherein the means for determining the clock offsets between anchor units comprise:
means for determining an estimate of the distance between a first anchor unit of the anchor units and a second anchor unit of the anchor units, the distance estimate being based on two-way time-of-flight information between the first anchor unit and the second anchor unit; and
means for determining the clock offset between the first anchor unit and the second anchor unit based on the distance estimate.

17. The system of claim 15, further comprising:
means for identifying a first group of the anchor units and a second group of the anchor units different from the first group;
means for scheduling the wireless transmission of ranging information from anchor units in the first group to anchor units in the second group during a first period of time, and from anchor units in the second group to anchor units in the first group during a second period of time subsequent to the first period of time; and
means for determining the clock offsets between the anchor units based on two-way time-of-flight information resulting from the transmission of ranging information during the first period of time and during the second period of time.

18. The system of claim 17, wherein:
the ranging information transmitted during the first period of time and during the second period of time is transmitted using a first frequency spectrum, and
the one or more signals transmitted by the tag are transmitted using a second frequency spectrum different from the first frequency spectrum.

19. The system of claim 15, further comprising:
means for identifying one of the anchor units as a reference anchor unit; and
means for determining a clock offset between each of the other anchor units and the reference anchor unit based on the clock offsets between the anchor units.

20. The system of claim 15, wherein the means for determining the clock offsets between anchor units comprise:
means for determining an estimate of the distance between a first anchor unit of the anchor units and a second anchor unit of the anchor units, the distance estimate being based on information in a packet received by the second anchor unit from the first anchor unit; and
means for determining the clock offset between the first anchor unit and the second anchor unit based on the distance estimate.

21. The system of claim 20, wherein the packet information includes a timestamp that indicates a time of transmission of the packet from the first anchor unit.

22. The system of claim 20, wherein the packet information includes a ranging preamble configured to determine a time of arrival of the packet at the second anchor unit.

23. The system of claim 20, wherein:
the packet is received by the second anchor unit via a first frequency spectrum, the information in the packet including a ranging preamble configured to determine a time of arrival of the packet at the second anchor unit; and
a timestamp is received by the second anchor unit via a second frequency spectrum different from the first frequency spectrum, the timestamp indicating a time of transmission of the packet from the first anchor unit.

24. The system of claim 20, further comprising:
means for determining a time of arrival of the packet at the second anchor unit based on a ranging preamble in the packet information; and
means for determining the distance estimate based on the time of arrival of the packet.

25. The system of claim 15, wherein the means for determining the clock offsets between anchor units comprise:
means for sending packets between a first anchor unit of the anchor units and a second anchor unit of the anchor units, wherein a timing of the sending of the packets and a timing of the receiving of the packets are utilized to determine the clock offset between the first anchor unit and the second anchor unit when a line-of-sight between the first anchor unit and the second anchor unit is blocked.

26. The system of claim 15, further comprising:
means for identifying a subset of the anchor units that do not have a main path between two anchor units blocked; and
means for determining the clock offsets between anchor units from the subset of the anchor units.

27. The system of claim 15, wherein the means for determining the clock offsets between anchor units comprise:
means for identifying one of the anchor units as a master reference anchor unit;
means for synchronizing the master reference anchor unit to one or more of the remaining anchor units; and
means for identifying at least one acting reference anchor unit from the one or more of anchor units synchronized to the master reference anchor unit.

28. The system of claim 27, wherein the means for determining the clock offsets between anchor units further comprise:
means for identifying an additional at least one acting reference unit from one or more anchor units synchronized to the at least one acting reference anchor unit.

29. A location tracking device, comprising:
at least one processor communicatively coupled with a memory, the memory comprising executable code that, when executed by the at least one processor, causes the at least one processor to:
determine clock offsets between anchor units configured to track an asset or person the determination being based on signals wirelessly transmitted between the anchor units;
determine range measurements between a tag attached to the asset or person and at least a portion of the anchor units, wherein the range measurements are based on information in one or more signals transmitted by the tag when the tag is at a particular location, and on the clock offsets of the at least a portion of the anchor units; and
determine an estimate of the particular location from which the tag transmitted the one or more signals based on the range measurements.

30. The device of claim 29, wherein the executable code causes the at least one processor to:
determine an estimate of the distance between a first anchor unit of the anchor units and a second anchor unit of the anchor units, the distance estimate being based on two-way time-of-flight information between the first anchor unit and the second anchor unit; and
determine the clock offset between the first anchor unit and the second anchor unit based on the distance estimate.

31. The device of claim 29, wherein the executable code causes the at least one processor to:
identify a first group of the anchor units and a second group of the anchor units different from the group portion;
schedule the wireless transmission of ranging information from anchor units in the group portion to anchor units in the second group during a first period of time, and from anchor units in the second group to anchor units in the first group during a second period of time subsequent to the first period of time; and
determine the clock offsets between the anchor units based on two-way time-of-flight information resulting from the transmission of ranging information during the first period of time and during the second period of time.

32. The device of claim 31, wherein:
the ranging information transmitted during the first period of time and during the second period of time is transmitted using a first frequency spectrum, and
the one or more signals transmitted by the tag are transmitted using a second frequency spectrum different from the first frequency spectrum.

33. The device of claim 29, wherein the executable code causes the at least one processor to:
identify one of the anchor units as a reference anchor unit; and
determine a clock offset between each of the other anchor units and the reference anchor unit based on the clock offsets between the anchor units.

34. The device of claim 29, wherein the executable code causes the at least one processor to:
determine an estimate of the distance between a first anchor unit of the anchor units and a second anchor unit of the anchor units, the distance estimate being based on information in a packet received by the second anchor unit from the first anchor unit; and
determine the clock offset between the first anchor unit and the second anchor unit based on the distance estimate.

35. The device of claim 34, wherein the packet information includes a timestamp that indicates a time of transmission of the packet from the first anchor unit.

36. The device of claim 34, wherein the packet information includes a ranging preamble configured to determine a time of arrival of the packet at the second anchor unit.

37. The device of claim 34, wherein:
the packet is received by the second anchor unit via a first frequency spectrum, the information in the packet including a ranging preamble configured to determine a time of arrival of the packet at the second anchor unit; and
a timestamp is received by the second anchor unit via a second frequency spectrum different from the first frequency spectrum, the timestamp indicating a time of transmission of the packet from the first anchor unit.

38. The device of claim 34, wherein the executable code causes the at least one processor to:
determine a time of arrival of the packet at the second anchor unit based on a ranging preamble in the packet information; and
determine the distance estimate based on the time of arrival of the packet.

39. The device of claim 29, wherein the executable code causes the at least one processor to:
send packets between a first anchor unit of the anchor units and a second anchor unit of the anchor units, wherein a timing of the sending of the packets and a timing of the receiving of the packets are utilized to determine the clock offset between the first anchor unit and the second anchor unit when a line-of-sight between the first anchor unit and the second anchor unit is blocked.

40. The device of claim 29, wherein the executable code causes the at least one processor to:
identify a subset of the anchor units that do not have a main path between two anchor units blocked; and
determine the clock offsets between anchor units from the subset of the anchor units.

41. The device of claim 29, wherein the executable code causes the at least one processor to:
identify one of the anchor units as a master reference anchor unit;
synchronize the master reference anchor unit to one or more of the remaining anchor units; and
identify at least one acting reference anchor unit from the one or more of anchor units synchronized to the master reference anchor unit.

42. The device of claim 41, wherein the executable code causes the at least one processor to:
identify an additional at least one acting reference unit from one or more anchor units synchronized to the at least one acting reference anchor unit.

43. A computer program product for location tracking, comprising:
a non-transitory computer-readable medium comprising:
code configured to determine clock offsets between anchor units configured to track an asset or person, the determination being based on signals wirelessly transmitted between the anchor units;
code configured to determine range measurements between a tag attached to the asset or person and at least a portion of the anchor units, wherein the range measurements are based on information in one or more signals transmitted by the tag when the tag is at a particular location, and on the clock offsets of the at least a portion of the anchor units; and
code configured to determine an estimate of the particular location from which the tag transmitted the one or more signals based on the range measurements.

44. The computer program product of claim 43, wherein the non-transitory computer-readable medium comprises:
code configured to determine an estimate of the distance between a first anchor unit of the anchor units and a second anchor unit of the anchor units, the distance estimate being based on two-way time-of-flight information between the first anchor unit and the second anchor unit; and
code configured to determine the clock offset between the first anchor unit and the second anchor unit based on the distance estimate.

45. The computer program product of claim 43, wherein the non-transitory computer-readable medium comprises:
code configured to identify a first group of the anchor units and a second group of the anchor units different from the first group;
code configured to schedule the wireless transmission of ranging information from anchor units in the first group to anchor units in the second group during a first period of time, and from anchor units in the second group to anchor units in the first group during a second period of time subsequent to the first period of time; and
code configured to determine the clock offsets between the anchor units based on two-way time-of-flight information resulting from the transmission of ranging information during the first period of time and during the second period of time.

46. The computer program product of claim 45, wherein:
the ranging information transmitted during the first period of time and during the second period of time is transmitted using a first frequency spectrum, and
the one or more signals transmitted by the tag are transmitted using a second frequency spectrum different from the first frequency spectrum.

47. The computer program product of claim 43, wherein the non-transitory computer-readable medium comprises:
code configured to identify one of the anchor units as a reference anchor unit; and
code configured to determine a clock offset between each of the other anchor units and the reference anchor unit based on the clock offsets between the anchor units.

48. The computer program product of claim 43, wherein the non-transitory computer-readable medium comprises:
code configured to determine an estimate of the distance between a first anchor unit of the anchor units and a second anchor unit of the anchor units, the distance estimate being based on information in a packet received by the second anchor unit from the first anchor unit; and
code configured to determine the clock offset between the first anchor unit and the second anchor unit based on the distance estimate.

49. The computer program product of claim 48, wherein the packet information includes a timestamp that indicates a time of transmission of the packet from the first anchor unit.

50. The computer program product of claim 48, wherein the packet information includes a ranging preamble configured to determine a time of arrival of the packet at the second anchor unit.

51. The computer program product of claim 48, wherein:
the packet is received by the second anchor unit via a first frequency spectrum, the information in the packet including a ranging preamble configured to determine a time of arrival of the packet at the second anchor unit; and
a timestamp is received by the second anchor unit via a second frequency spectrum different from the first frequency spectrum, the timestamp indicating a time of transmission of the packet from the first anchor unit.

52. The computer program product of claim 48, wherein the non-transitory computer-readable medium comprises:
code configured to determine a time of arrival of the packet at the second anchor unit based on a ranging preamble in the packet information; and
code configured to determine the distance estimate based on the time of arrival of the packet.

53. The computer program product of claim 43, wherein the non-transitory computer-readable medium comprises:
code configured to send packets between a first anchor unit of the anchor units and a second anchor unit of the anchor units, wherein a timing of the sending of the packets and a timing of the receiving of the packets are utilized to determine the clock offset between the first anchor unit and the second anchor unit when a line-of-sight between the first anchor unit and the second anchor unit is blocked.

54. The computer program product of claim 43, wherein the non-transitory computer-readable medium comprises:
code configured to identify a subset of the anchor units that do not have a main path between two anchor units blocked; and
code configured to determine the clock offsets between anchor units from the subset of the anchor units.

55. The computer program product of claim 43, wherein the non-transitory computer-readable medium comprises:
code configured to identify one of the anchor units as a master reference anchor unit;
code configured to synchronize the master reference anchor unit to one or more of the remaining anchor units; and
code configured to identify at least one acting reference anchor unit from the one or more of anchor units synchronized to the master reference anchor unit.

56. The computer program product of claim 55, wherein the non-transitory computer-readable medium comprises:
code configured to identify an additional at least one acting reference unit from one or more anchor units synchronized to the at least one acting reference anchor unit.
